(19) United States
(12) Patent Application Publication
(10) Pub. No.: US 2023/0089954 A1
(43) Pub. Date: Mar. 23, 2023

(54) CUSHIONING ARTICLE FILM HAVING RECLAIMED CONTENT

(71) Applicant: Sealed Air Corporation (US), Charlotte, NC (US)

(72) Inventors: Janet Rivett, Charlotte, NC (US); Drew V. Speer, Charlotte, NC (US)

(21) Appl. No.: 17/802,373

(22) PCT Filed: Feb. 25, 2021
(86) PCT No.: PCT/US2021/019554

§ 371 Date: Aug. 25, 2022

Related U.S. Application Data
(60) Provisional application No. 62/981,672, filed on Feb. 26, 2020.

(51) Int. Cl. B32B 3/26; B32B 3/06; B32B 7/027; B32B 27/34; B32B 27/30; B32B 27/32; B65D 81/05; B32B 27/18

(52) U.S. Cl. CPC B32B 3/26; B32B 3/06; B32B 7/027; B32B 27/34; B32B 27/306; B32B 27/32; B65D 81/052; B32B 27/18; B32B 2307/7244; B32B 2307/31; B32B 2307/54

(57) ABSTRACT

A multi-layer film, a cushioning article and a method of manufacture a cushioning article from the multi-layer film is disclosed. The multi-layer film having a barrier layer that includes a compatibilizer. The film having an oxygen transmission rate sufficient to contain a fluid to form a cushioning article.

### BACKGROUND

The subject matter disclosed herein relates to the field of cushioning article film. More particularly to fluid filled films suited for cushioning articles.

Cushioning articles such as cellular cushioning articles are typically used for cushioning items that may be fragile or otherwise need protection. Cellular cushioning articles have included with formed pockets being filled with air to define individual cells or bubbles. In addition, inflatable cellular cushioning articles such as pillows are typically used for void fill and to offer some protection.

Utilizing a recycle stream of polymers can divert these materials from the landfill to useful products while also reducing the demand for virgin materials. Unfortunately, most recycle streams of polymers include a number of impurities or additional components that make it difficult to use in a polyolefin containing material. Furthermore, recycling polymers can result in altering the physical properties, shortening polymer chains and lead to thermal degradation of the polymer. Many recycle streams contain scrap materials and mixtures of materials that cannot be easily reused since the impurities, including but not limited to polyamide, ethylene vinyl alcohol, polypropylene, polyester, act as heat resistant materials and generally do not melt and flow at the similar low temperatures as other polyolefin resins (such a polyethylene). This makes processability difficult and introduces additional challenges to utilizing recycle streams. To avoid these issues, many recycle streams will attempt to eliminate or greatly reduce the amount of impurities and other material that prohibits melt and flow. For example, by limiting heat resistant materials concentration to very low levels, the material may still flow at reasonable temperatures.

Therefore, the ability to use a polymer recycle stream without greatly restrictions the amount of heat resistant materials to manufacture cushioning articles is desirable.

The discussion above is merely provided for general background information and is not intended to be used as an aid in determining the scope of the claimed subject matter.

### BRIEF DESCRIPTION

A multi-layer film, a cushioning article and a method of manufacture a cushioning article from the multi-layer film is disclosed. The multi-layer film having at least 25% scrap material content and a barrier layer. The scrap material including a blend of polymers. The film having an oxygen transmission rate sufficient to contain a fluid to form a cushioning article.

An advantage that may be realized in the practice of some disclosed embodiments of the film is the use of scrap material included in a useful article.

In one exemplary embodiment, a multi-layer film is disclosed. The multi-layer film comprises at least one heat seal layer having a seal initiation temperature of less than any of the following temperatures: 220° C., 210° C., 200° C., 190° C., 180° C., 170° C., 160° C., 150° C., 140° C. and 130° C.; at least one barrier layer comprising a blend of a polyolefin and at least one heat resistant polymer selected from the group consisting of polyamide, ethylene vinyl alcohol, polypropylene, polyester, and blends thereof. The barrier layer having a calculated composite melt index of less than 1.0, or 0.5 g/10 min @190° C. and 2.16 kg measured in accordance with ASTM D1238. The heat resistant polymer comprising at least 7.0, 7.5, 8.0, 8.5, 9.0, 9.5 or 10 wt % the total weight of the barrier layer; and at least 0.5 wt % of a compatibilizer. The multi-layer film structure having an oxygen transmission rate of no more than: 1000, 1100, 1200, 1300, 1400, 1500, 1600, 1700, 1800, 1900, 2000, 2100, 2200, 2300, 2400, 2500, 2600, 2700, 2800, 2900 or 3000 cubic centimeters (at standard temperature and pressure) per square meter per day per 1 atmosphere of oxygen pressure differential measured at 0% relative humidity and 23° C. measured according to ASTM D-3985.

In another exemplary embodiment, the multi-layer film forms a cushioning article comprising a first multi-layer film structure. The first multi-layer film structure including at least one heat seal layer having a seal initiation temperature of less than any of the following temperatures: 220° C., 210° C., 200° C., 190° C., 180° C., 170° C., 160° C., 150° C., 140° C. and 130° C.; at least one barrier layer comprising a blend of a polyolefin and at least one heat resistant polymer selected from the group consisting of polyamide, ethylene vinyl alcohol, polypropylene, polyester, and blends thereof; and at least 0.5 wt % of a compatibilizer. The barrier layer having a calculated composite melt index of less than 0.5 g/10 min @190° C. and 2.16 kg measured in accordance with ASTM D1238. The heat resistant polymer comprising at least 7.0, 7.5, 8.0, 8.5, 9.0, 9.5 or 10 wt % the total weight of the barrier layer. The first multi-layer film structure has an oxygen transmission rate of no more than: 1000, 1100, 1200, 1300, 1400, 1500, 1600, 1700, 1800, 1900, 2000, 2100, 2200, 2300, 2400, 2500, 2600, 2700, 2800, 2900 or 3000 cubic centimeters (at standard temperature and pressure) per square meter per day per 1 atmosphere of oxygen pressure differential measured at 0% relative humidity and 23° C. measured according to ASTM D-3985. The heat seal layer of the first multi-layer film structure being bonded to itself or a second film.

In another exemplary embodiment, a method of making a cushioning article is disclosed. The method comprises the steps of a) providing a multilayer film; b) bonding the multilayer film to itself or a second film; c) forming a cushioning article according; d) filing the cushioning article with a fluid; and e) sealing the cushioning article to seal the fluid within the bonded multilayer film(s). The multilayer film including at least one heat seal layer having a seal initiation temperature of less than any of the following temperatures: 220° C., 210° C., 200° C., 190° C., 180° C., 170° C., 160° C., 150° C., 140° C. and 130° C.; at least one barrier layer comprising a blend of a polyolefin and at least one heat resistant polymer selected from the group consisting of polyamide, ethylene vinyl alcohol, polypropylene, polyester, and blends thereof; and at least 0.5 wt % of a compatibilizer. The barrier layer having a calculated composite melt index of less than 0.5 g/10 min @190° C. and 2.16 kg measured in accordance with ASTM D1238. The heat resistant polymer comprising at least 7.0, 7.5, 8.0, 8.5, 9.0, 9.5 or 10 wt % the total weight of the barrier layer. The first multi-layer film structure has an oxygen transmission rate of no more than: 1000, 1100, 1200, 1300, 1400, 1500, 1600, 1700, 1800, 1900, 2000, 2100, 2200, 2300, 2400, 2500, 2600, 2700, 2800, 2900 or 3000 cubic centimeters (at standard temperature and pressure) per square meter per day per 1 atmosphere of oxygen pressure differential measured at 0% relative humidity and 23° C. measured according to ASTM D-3985.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1A is an exemplary exploded perspective view of an air chamber article suitable for use as a cushioning article for packaging;

FIG. 1B is a transverse cross-sectional view taken through section 7B-7B perspective view of the air chamber article suitable for use as a cushioning article for packaging shown in FIG. 1A;

FIG. 2 is a schematic of an integrated process for making an air cellular article including a downward cast processes for making both the formed film and the backing film portions of the composite air cellular article;

FIG. 3 is an exemplary perspective view of an air chamber article comprising a strand of pillows, and is suitable for use as a cushioning article for packaging;

FIG. 4 is an exemplary perspective view of an air chamber article comprising a strand of pillows suitable for use as a cushioning article for packaging;

FIG. 5 is an exemplary plan view of an uninflated, inflatable cellular cushioning article suitable for packaging;

FIG. 6 is an exemplary perspective view of an air chamber article having a grid of pillows separated by lengthwise and transverse seals; and

FIG. 7 is a schematic of a hot blown film process for making films to be used in the cushioning article.

### DETAILED DESCRIPTION

As used herein, the term “film” is inclusive of plastic web, regardless of whether it is film or sheet. The film can have a thickness of 0.25 mm or less, or a thickness of from 0.35 to 30 mils, or from 0.5 to 25 mils, or from 0.5 to 15 mils, or from 1 to 10 mils, or from 1 to 8 mils, or from 1.1 to 7 mils, or from 1.2 to 6 mils, or from 1.3 to 5 mils, or from 1.5 to 4 mils, or from 1.6 to 3.5 mils, or from 1.8 to 3.3 mils, or from 2 to 3 mils, or from 1.5 to 4 mils, or from 0.5 to 1.5 mils, or from 1 to 1.5 mils, or from 0.7 to 1.3 mils, or from 0.8 to 1.2 mils, or from 0.9 to 1.1 mils.

The multi-layer films described herein include at least one heat seal layer to allow the film to be sealed to itself or another film. The films further include at least one barrier layer to restrict fluid from permeating through the film. The films may further include additional layers, for example to add bulk, provide functionality, abuse resistance, printing capability or to act as a tie layer.

The multi-layer films described herein may comprise at least, and/or at most, any of the following numbers of layers: 2, 3, 4, 5, 6, 7, 8, 9, 10, 11, 12, 13, 14 and 15. As used herein, the term “layer” refers to a discrete film component which is substantially coextensive with the film and has a substantially uniform composition. Where two or more directly adjacent layers have essentially the same composition, then these two or more adjacent layers may be considered a single layer for the purposes of this application. In embodiments, the multilayer film utilizes microlayers. A microlayer section may include between 10 and 1,000 microlayers in each microlayer section.

Below are some examples of combinations in which the alphabetical symbols designate the film layers. Where the multilayer film representation below includes the same letter more than once, each occurrence of the letter may represent the same composition or a different composition within the class that performs a similar function.

A/B, A/B/A, A/C/B, A/B/D, A/D/B, A/C/D, A/B/D/A, A/C/D/B, A/D/C/B, A/C/B/D, A/B/C/D, A/C/B/A, A/B/C/A, A/C/B/C/A, A/C/D/C/B, A/D/B/C/A, A/C/B/D/A, A/C/D/B/C/A, A/C/D/B/D/C/A, A/C/B/B/A, A/C/B/B/C/A, A/C/B/D/B/C/A

“A” represents a heat seal layer, as discussed herein.

“B” represents a barrier layer, as discussed herein.

“C” represents an intermediate layer (e.g., a tie layer), as discussed herein.

“D” represents one or more other layers of the film, such as a bulk layer.

All compositional percentages used herein are presented on a “by weight” basis, unless designated otherwise.

As used herein, the phrases “seal layer”, “sealing layer”, “heat seal layer”, and “sealant layer”, refer to an outer layer, or layers, involved in the sealing of the film to itself, another layer of the same or another film, and/or another article which is not a film.

As used herein, the term “heat-seal,” and the phrase “heat-sealing,” refer to any seal of a first region of a film surface to a second region of a film surface, wherein the seal is formed by heating the regions to at least their respective seal initiation temperatures. Heat-sealing is the process of joining two or more thermoplastic films or sheets by heating areas in contact with each other to the temperature at which fusion occurs, usually aided by pressure. The heating can be performed by any one or more of a wide variety of manners, such as using a heated bar, hot wire, hot air, infrared radiation, ultraviolet radiation, electron beam, ultrasonic, and melt-bead. A heat seal is usually a relatively narrow seal (e.g., 0.02 inch to 1 inch wide) across a film. One particular heat sealing means is a heat seal made using an impulse sealer, which uses a combination of heat and pressure to form the seal, with the heating means providing a brief pulse of heat while pressure is being applied to the film by a seal bar or seal wire, followed by rapid cooling of the bar or wire.

Seal initiation temperature is the temperature to which the polymer must be heated before it will undergo useful bonding to itself under pressure. Therefore, heat sealing temperatures above the seal initiation temperature result in heat seals with considerable and measurable seal strength. Seal initiation temperature as used herein refers to a seal having a seal strength of at least 22.6 N/cm when sealed with a dwell time of about one second and a sealing pressure of 50 N/cm². After aging for at least 24 hours at 23° C. the seal strength is determined based on ASTM method D882. Sealed samples are cut into 25.4 mm wide pieces and then strength tested using a Zwick tensile meter at a strain rate of 500 mm/min and a 50 mm jaw separation. The free ends of the sample are fixed in jaws, and then the jaws are separated at the strain rate until the seal fails. The peak load at seal break is measured and the seal strength is calculated by dividing the peak load by the sample width.

Heat seal layers include thermoplastic polymers, including, but not limited to thermoplastic polyolefins, ethylene acrylic acid, ethylene methacrylic acid, and their ionomers. In embodiments, polymers for the sealant layer include homogeneous ethylene/alpha-olefin copolymer, heterogeneous ethylene/alpha-olefin copolymer, ethylene homopolymer, ethylene copolymer, and ethylene/vinyl acetate copolymer. In some embodiments, the heat seal layer can comprise a polyolefin, particularly an ethylene/alpha-olefin copolymer. For example, a polyolefin having a density of from 0.88 g/cc to 0.917 g/cc, or from 0.90 g/cc to 0.92 g/cc, or less than 0.95 g/cc. More particularly, the seal layer can comprise at least one member selected from the group consisting of linear low density, medium density polyethylene, low density polyethylene, very low density polyethylene, homogeneous ethylene/alpha-olefin copolymer, and polypropylene. “Polymer” herein refers to homopolymer, copolymer, terpolymer, etc. “Copolymer” herein includes copolymer, terpolymer, etc.

As used herein, the term “polyolefin” refers to olefin polymers and copolymers, especially ethylene and propylene polymers and copolymers, and to polymeric materials having at least one olefinic comonomer. Polyolefins can be linear, branched, cyclic, aliphatic, aromatic, substituted, or unsubstituted. Included in the term polyolefin are homopolymers of olefin, copolymers of olefin, copolymers of an olefin and a non-olefinic comonomer copolymerizable with the olefin, such as vinyl monomers, acrylics, modified polymers of the foregoing, and the like. Modified polyolefins include modified polymers prepared by copolymerizing or grafting the homopolymer of the olefin or copolymer thereof with an unsaturated carboxylic acid, e.g., maleic acid, fumaric acid or the like, or a derivative thereof such as the anhydride, ester metal salt of the carboxylic acid or the like. It could also be obtained by incorporating into the olefin homopolymer or copolymer, an unsaturated carboxylic acid, e.g., maleic acid, fumaric acid or the like, or a derivative thereof such as the anhydride, ester metal salt of the carboxylic acid or the like. In an embodiment, the heat seal layer is mainly composed of polyolefin. In an embodiment, the heat seal layer has a total polyolefin content of from 90 to 99 wt % based on the total composition of the heat seal layer.

Ethylene homopolymer or copolymer refers to ethylene homopolymer such as low density polyethylene, medium density polyethylene, high density polyethylene; ethylene/alpha olefin copolymer such as those defined hereinbelow; and other ethylene copolymers such as ethylene/vinyl acetate copolymer; ethylene/alkyl acrylate copolymer; or ethylene/(meth)acrylic acid copolymer. Ethylene/alpha-olefin copolymer herein refers to copolymers of ethylene with one or more comonomers selected from C4 to C10 alpha-olefins such as butene-1, hexene-1, octene-1, etc. in which the molecules of the copolymers comprise long polymer chains with relatively few side chain branches arising from the alpha-olefin which was reacted with ethylene. This molecular structure is to be contrasted with conventional high pressure low or medium density polyethylenes which are highly branched with respect to ethylene/alpha-olefin copolymers and which high pressure polyethylenes contain both long chain and short chain branches. Ethylene/alpha-olefin copolymers include one or more of the following: 1) high density polyethylene, for example having a density greater than 0.94 g/cm³, 2) medium density polyethylene, for example having a density of from 0.93 to 0.94 g/cm³, 3) linear medium density polyethylene, for example having a density of from 0.926 to 0.94 g g/cm³, 4) low density polyethylene, for example having a density of from 0.915 to 0.939 g/cm³, 5) linear low density polyethylene, for example having a density of from 0.915 to 0.935 g/cm³, 6) very-low or ultra-low density polyethylene, for example having density below 0.915 g/cm³, and homogeneous ethylene/alpha-olefin copolymers. Homogeneous ethylene/alpha-olefin copolymers include those having a density of less than about any of the following: 0.925, 0.922, 0.92, 0.917, 0.915, 0.912, 0.91, 0.907, 0.905, 0.903, 0.90, and 0.86 g/cm³. Unless otherwise indicated, all densities herein are measured according to ASTM D1505.

“Polyamide” herein refers to polymers having amide linkages along the molecular chain, and preferably to synthetic polyamides such as nylons. Furthermore, such term encompasses both polymers comprising repeating units derived from monomers, such as caprolactam, which polymerize to form a polyamide, as well as polymers of diamines and diacids, and copolymers of two or more amide monomers, including nylon terpolymers, sometimes referred to in the art as “copolyamides”. “Polyamide” specifically includes those aliphatic polyamides or copolyamides commonly referred to as e.g. polyamide 6 (homopolymer based on ε-caprolactam), polyamide 69 (homopolycondensate based on hexamethylene diamine and azelaic acid), polyamide 610 (homopolycondensate based on hexamethylene diamine and sebacic acid), polyamide 612 (homopolycondensate based on hexamethylene diamine and dodecandioic acid), polyamide 11 (homopolymer based on 11-aminoundecanoic acid), polyamide 12 (homopolymer based on w-aminododecanoic acid or on laurolactam), polyamide 6/12 (polyamide copolymer based on ε-caprolactam and laurolactam), polyamide 6/66 (polyamide copolymer based on ε-caprolactam and hexamethylenediamine and adipic acid), polyamide 66/610 (polyamide copolymers based on hexamethylenediamine, adipic acid and sebacic acid), modifications thereof and blends thereof. Polyamide also includes crystalline or partially crystalline, amorphous (6I/6T), aromatic or partially aromatic, polyamides.

As used herein, “Polyesters” includes polymers made by: 1) condensation of polyfunctional carboxylic acids with polyfunctional alcohols, 2) polycondensation of hydroxycarboxylic acid, and 3) polymerization of cyclic esters (e.g., lactone).

Exemplary polyfunctional carboxylic acids (which includes their derivatives such as anhydrides or simple esters like methyl esters) include aromatic dicarboxylic acids and derivatives (e.g., terephthalic acid, isophthalic acid, dimethyl terephthalate, dimethyl isophthalate, naphthalene-2,6-dicarboxylic acid) and aliphatic dicarboxylic acids and derivatives (e.g., adipic acid, azelaic acid, sebacic acid, oxalic acid, succinic acid, glutaric acid, dodecanoic diacid, 1,4-cyclohexane dicarboxylic acid, dimethyl-1,4-cyclohexane dicarboxylate ester, dimethyl adipate). Representative dicarboxylic acids may be represented by the general formula:

HOOC—Z—COOH

where Z is representative of a divalent aliphatic radical containing at least 2 carbon atoms. Representative examples include adipic acid, sebacic acid, octadecanedioic acid, pimelic acid, suberic acid, azelaic acid, dodecanedioic acid, and glutaric acid. The dicarboxylic acids may be aliphatic acids, or aromatic acids such as isophthalic acid (“I”) and terephthalic acid (“T”). As is known to those of skill in the art, polyesters may be produced using anhydrides and esters of polyfunctional carboxylic acids.

Exemplary polyfunctional alcohols include dihydric alcohols (and bisphenols) such as ethylene glycol, 1,2- propanediol, 1,3-propanediol, 1,3 butanediol, 1,4-butanediol, 1,4-cyclohexanedimethanol, 2,2-dimethyl-1,3-propanediol, 1,6-hexanediol, poly(tetrahydroxy-1,1′-biphenyl, 1,4-hydroquinone, bisphenol A, and cyclohexane dimethanol (“CHDM”).

Exemplary hydroxycarboxylic acids and lactones include 4-hydroxybenzoic acid, 6-hydroxy-2-naphthoic acid, pivalolactone, and caprolactone.

Exemplary polyesters may be derived from lactone polymerization; these include, for example, polycaprolactone and polylactic acid.

The polyester may comprise or be modified polyester. Exemplary modified polyester includes glycol-modified polyester and acid-modified polyester. Modified polyesters are made by polymerization with more than one type of comonomer in order to disrupt the crystallinity and thus render the resulting polyester more amorphous.

A glycol-modified polyester is a polyester derived by the condensation of at least one polyfunctional carboxylic acid with at least two types of polyfunctional alcohols. For example, glycol-modified poly(ethylene terephthalate) or “PETG” may be made by condensing terephthalic acid with ethylene glycol and cyclohexane dimethanol (“CHDM”). A useful PETG is available from Eastman Corporation under the Eastar 6763 trade name, and is believed to have about 34 mole % CHDM monomer content, about 16 mole % ethylene glycol monomer content, and about 50 mole % terephthalic acid monomer content. Another useful glycol-modified polyester may be made similar to PETG, but substituting dimethyl terephthalate for the terephthalic acid component. Another exemplary glycol-modified polyester is available under the Ecdel 9965 trade name from Eastman Corporation, and is believed to have a density of 1.13 g/cc and a melting point of 195° C. and to be derived from dimethyl 1,4 cyclohexane-dicarboxylate, 1,4 cyclohexane-dimethanol, and poly (tetramethylene ether glycol).

Exemplary acid-modified polyester may be made by condensation of at least one polyfunctional alcohol with at least two types of polyfunctional carboxylic acids. For example, at least one of the polyfunctional alcohols listed above may be condensed with two or more of the polyfunctional carboxylic acids listed above (e.g., isophthalate acid, adipic acid, and/or Naphthalene-2,6-dicarboxylic acid). An exemplary acid-modified polyester may be derived from about 5 mole % isophthalic acid, about 45 mole % terephthalic acid, and about 50 mole % ethylene glycol, such as that available from Invista Corporation.

The polyester may be selected from random polymerized polyester or block polymerized polyester.

The polyester may be derived from one or more of any of the constituents discussed above. If the polyester includes a mer unit derived from terephthalic acid, then such mer content (mole %) of the diacid of the polyester may be at least about any the following: 70, 75, 80, 85, 90, and 95%.

The polyester may be thermoplastic. The polyester may be substantially amorphous, or may be partially crystalline (semi-crystalline). The polyester and/or the skin layer may have a crystallinity of at least about, and/or at most about, any of the following weight percentages: 5, 10, 15, 20, 25, 30, 35, 40, and 50%.

The crystallinity may be determined indirectly by the thermal analysis method, which uses heat-of-fusion measurements made by differential scanning calorimetry (“DSC”). All references to crystallinity percentages of a polymer, a polymer mixture, a resin, a film, or a layer in this Application are by the DSC thermal analysis method, unless otherwise noted. The DSC thermal analysis method is believed to be the most widely used method for estimating polymer crystallinity, and thus appropriate procedures are known to those of skill in the art. See, for example, “Crystallinity Determination,” Encyclopedia of Polymer Science and Engineering, Volume 4, pages 482-520 (John Wiley & Sons, 1986), of which pages 482-520 are incorporated herein by reference.

Under the DSC thermal analysis method, the weight fraction degree of crystallinity (i.e., the “crystallinity” or “Wc”) is defined as ΔHi/ΔHi where “ΔHP is the measured heat of fusion for the sample (i.e., the area under the heat-flow versus temperature curve for the sample) and “AHf,c” is the theoretical heat of fusion of a 100% crystalline sample. The AHf,c values for numerous polymers have been obtained by extrapolation methods; see for example, Table 1, page 487 of the “Crystallinity Determination” reference cited above. The AHf,c for polymers are known to, or obtainable by, those of skill in the art. The AHf,c for a sample polymer material may be based on a known AHf,c for the same or similar class of polymer material, as is known to those of skill in the art. For example, the AHf,c for polyethylene may be used in calculating the crystallinity of an EVA material, since it is believed that it is the polyethylene backbone of EVA rather than the vinyl acetate pendant portions of EVA that forms crystals. Also by way of example, for a sample containing a blend of polymer materials, the AHf,c for the blend may be estimated using a weighted average of the appropriate AHf,c for each of the polymer materials of separate classes in the blend.

The DSC measurements may be made using a thermal gradient for the DSC of 10° C./minute. The sample size for the DSC may be from 5 to 20 mg.

In various embodiment, the heat seal layer has a melting point less than any of the following values: 220° C., 210° C., 200° C., 190° C., 180° C., 170° C., 160° C., 150° C., 140° C. and 130° C.; and the melting point of the heat seal layer may be at least any of the following values: 50° C., 60° C., 70,° C., 80° C., 90° C., 100° C., 110° C., 120° C., 130° C., 140° C., and 150° C. In an embodiment, the heat seal layer comprises from 80 to 99 wt % of a linear low density polyethylene copolymer having a melting point between 90-130° C. In an embodiment, the heat seal layer comprises from 80 to 99 wt % of a very low density polyethylene copolymer having a melting point between 85-125° C. All references to the melting point of a polymer, a resin, or a film layer in this application refer to the melting peak temperature of the dominant melting phase of the polymer, resin, or layer as determined by differential scanning calorimetry according to ASTM D-3418.

In embodiments where the heat seal layer comprises amorphous material, then the heat seal layer may not clearly display a melting point. The glass transition temperature for the heat seal layer may be less than, and may range between, any of the following values: 125° C., 120° C., 110° C., 100° C., 90° C., 80° C., 70° C., 60° C., 50° C., 40° C., 30° C. and 25° C.; measured where the relative humidity may be any of the following values: 100%, 75%, 50%, 25%, and 0%. All references to the glass transition temperature (T_{g}) of a polymer was determined by the Perkin Elmer “half Cp extrapolated” (the “half Cp extrapolated” reports the point on the curve where the specific heat change is half of the change in the complete transition) following the ASTM D3418 “Standard Test Method of Transition Temperatures of Polymers by Thermal Analysis,” which is hereby incorporated, in its entirety, by reference thereto.

In various embodiment, the heat seal layer has a seal initiation temperature less than any of the following values: 220° C., 210° C., 200° C., 190° C., 180° C., 170° C., 160° C., 150° C., 140° C. and 130° C.; and the seal initiation temperature of the heat seal layer may be at least any of the following values: 50° C., 60° C., 70° C., 80° C., 90° C., 100° C., 110° C., 120° C., 130° C., 140° C., and 150° C.

In an embodiment the heat seal layer has a melt index or composite melt index of at least 0.3, 0.5, 1.0, 1.5, 2.0, 2.5, 3.0, 4.0, 5.0, 6.0, 7.0, 8.0, 9.0 or 10 g/10 min @190° C. and 2.16 kg measured in accordance with ASTM D1238.

The thickness of the heat seal layer may be selected to provide sufficient material to affect a strong heat seal bond, yet not so thick so as to negatively affect the characteristics of the film to an unacceptable level. The heat seal layer may have a thickness of at least any of the following values: 0.05 mils, 0.1 mils, 0.15 mils, 0.2 mils, 0.25 mils, 0.3 mils, 0.35 mils, 0.4 mils, 0.45 mils, 0.5 mils, and 0.6 mils. The heat seal layer may have a thickness less than any of the following values: 5 mils, 4 mils, 3 mils, 2 mils, 1 mil, 0.7 mils, 0.5 mils, and 0.3 mils. The thickness of the heat seal layer as a percentage of the total thickness of the film may be less that any of the following values: 50%, 40%, 30%, 25%, 20%, 15%, 10%, and 5%; and may range between any of the forgoing values (e.g., from 10% to 30%).

Barrier Layer

In embodiments, the barrier layer includes a blend of a number of materials and may be made from scrap content. As used herein, “scrap content” refers to materials that originate from a non-virgin source. The scrap content can be reclaimed from materials including, but not limited to, cut scraps; trimmed materials; transition materials; off spec material; start up, shut down or flush material, post-industrial and post-consumer recycled materials. The amount of scrap content in a layer/film is calculated based on the percent weight of scrap material as compared to other materials in the layer/film. The multilayer film used for forming a cushioning article further includes a barrier layer. As used herein, the term “barrier”, and the phrase “barrier layer”, as applied to films and/or film layers, are used with reference to the ability of a film or film layer to serve as a barrier to one or more gases. Oxygen transmission rate is one method to quantify the effect of a barrier layer. As used herein, the term “oxygen transmission rate” refers to the oxygen transmitted through a film in accordance with ASTM D3985 “Standard Test Method for Oxygen Gas Transmission Rate Through Plastic Film and Sheeting Using a Coulometric Sensor,” which is hereby incorporated, in its entirety, by reference thereto.

In embodiments, the barrier layer includes a blend of a number of materials and may be made from recycled or scrap content. The barrier layer includes a polyolefin such as polyethylene as a first component and at least one heat resistant polymer or blend of heat resistant polymers as a second component. The heat resistant polymer has a melting point (if present) of at least any of the following values: 250° C., 240° C., 230° C., 220° C., 210° C., 200° C., 190° C., 180° C., 170° C., 160° C., 150° C., 140° C., 130° C. and 120° C. The second component including polyamide, ethylene vinyl alcohol, polypropylene, polyester, and blends thereof. To aid in miscibility of the blend, compatibilizers and antioxidants are included. Useful compatibilizers include, ethylene acrylic acid copolymers and ethylene-methacrylic-acid-copolymers. In embodiments the compatibilizer is present in the polymeric mixture in an amount between 1 and 10 wt %. In an embodiment the compatibilizer is present in the polymeric mixture at no more than 10 wt %.

In an embodiment, the barrier layer includes between any of 5 and 95 wt %, 7 and 90 wt %, 10 and 85 wt %, 15 and 80 wt %, 20 and 70 wt % polyolefin. In embodiments, the barrier layer has less than 95 wt % polyolefin. In embodiments, the barrier layer has less than 90 wt % polyolefin. In embodiments, the polyolefin is a polyethylene or polyethylene copolymer.

The heat resistant polymer is present in the barrier layer in an amount of at least 5 wt %, 6 wt %, 7 wt %, 8 wt %, 9 wt %, 10 wt %, 15 wt %, 20 wt %, 25 wt %, 30 wt %, 40 wt %, 50 wt %, 60 wt %, 70 wt %, 80 wt %, 90 wt % or 95 wt % as compared to the total weight of the barrier layer. In various embodiments, the heat resistant polymer is present in the barrier layer in an amount between 5 and 95 wt %, between 10 and 90 wt %, between 15 and 70 wt %, between 20 and 60 wt %, or between 25 and 50 wt % as compared to the total weight of the barrier layer.

In an embodiment, the heat resistant polymer is a polyamide. The polyamide being present in amount of at least 8 wt %, 9 wt %, 10 wt %, 15 wt %, 20 wt %, 25 wt %, 30 wt %, 40 wt %, 50 wt %, 60 wt %, 70 wt %, 80 wt %, 90 wt % or 95 wt % as compared to the total weight of the barrier layer. In an embodiment, the polyamide is present in amount between 15 and 30 wt %. In an embodiment, the polyamide is polyamide 6, polyamide 6/66, amorphous (6I/6T) or blends thereof

In an embodiment, the heat resistant polymer is ethylene vinyl alcohol. The ethylene vinyl alcohol being present in amount of at least 4 wt %, 5 wt %, 6 wt %, 7 wt %, 8 wt %, 9 wt %, 10 wt %, 15 wt %, 20 wt %, 25 wt %, 30 wt %, 40 wt %, 50 wt %, 60 wt %, 70 wt %, 80 wt %, 90 wt % or 95 wt % as compared to the total weight of the barrier layer.

In an embodiment, the heat resistant polymer is a polyester. The polyester being present in amount of at least 4 wt %, 5 wt %, 6 wt %, 7 wt %, 8 wt %, 9 wt %, 10 wt %, 15 wt %, 20 wt %, 25 wt %, 30 wt %, 40 wt %, 50 wt %, 60 wt %, 70 wt %, 80 wt %, 90 wt % or 95 wt % as compared to the total weight of the barrier layer. In an embodiment, the polyester is present in amount of at between 4 and 80 wt %, 6 and 60 wt %, 8 and 40 wt % or 10 and 20 wt % as compared to the total weight of the barrier layer.

In an embodiment, the heat resistant polymer is polypropylene. The polypropylene being present in amount of at least 4 wt %, 5 wt %, 6 wt %, 7 wt %, 8 wt %, 9 wt %, 10 wt %, 15 wt %, 20 wt %, 25 wt %, 30 wt %, 40 wt %, 50 wt %, 60 wt %, 70 wt %, 80 wt %, 90 wt % or 95 wt % as compared to the total weight of the barrier layer. In an embodiment, the polypropylene is present in amount of at between 4 and 80 wt %, 6 and 60 wt %, 8 and 40 wt % or 10 and 20 wt % as compared to the total weight of the barrier layer.

In an embodiment, the barrier layer is a blend of materials that includes polyethylene and at least two of polyamide, ethylene vinyl alcohol, polypropylene, polyester. In an embodiment, the barrier layer is a blend of materials that includes polyethylene and at least three of polyamide, ethylene vinyl alcohol, polypropylene, polyester. In an embodiment, the barrier layer is a blend of materials that includes polyethylene, polyamide, ethylene vinyl alcohol, polypropylene, polyester. In an embodiment, the barrier layer includes at least 8%, 9%, 10%, 10%, 11%, 12%, 13%, 14%, 15%, 16%, 17%, 18%, 19%, 20%, 25%, 30%, 35% or 40% polyamide and at least 4%, 5%, 6%, 7%, 8%, 9% or 10% ethylene vinyl alcohol. In an embodiment, the barrier layer further includes at least 4%, 5%, 6%, 7%, 8%, 9%, 10%, 15%, 20% or 25% polypropylene and/or polyester.

In an embodiment the barrier layer has a melt index of less than 1.0, 0.5, 0.4, 0.3, 0.2, 0.1 g/10 min @190° C. and 2.16 kg measured in accordance with ASTM D1238. In an embodiment the barrier layer may have zero melt index @190° C. and 2.16 kg measured in accordance with ASTM D1238.

In an embodiment the barrier layer further includes 0.05-5.0 wt % of an antioxidant. An antioxidant, as defined herein, is any material which inhibits oxidative degradation or cross-linking of polymers. Examples of antioxidants suitable for use are, for example, hindered phenolics, such as, 2,6-di(t-butyl)4-methyl-phenol (BHT), 2,2″-methylene-bis(6-t-butyl-p-cresol); phosphites, such as, triphenylphosphite, tris-(nonylphenyl)phosphite; and thiols, such as, dilaurylthiodipropionate; pentaerythritol tetrakis(3-(3,5-di-tert-butyl hydroxyphenyl)propionate); octadecyl 3-(3,5-di-tert-butyl-4-hydroxyphenyl)propionate and the like.

In various embodiments, the barrier layer has a melting point of at least any of the following values: 250° C., 240° C., 230° C., 220° C., 210° C., 200° C., 190° C., 180° C., 170° C., 160° C., 150° C., 140° C., 130° C. and 120° C.; and the melting point of the barrier layer may be less than any of the following values: 300° C., 290° C., 280° C., 270° C., 260° C., and 250° C. All references to the melting point of a polymer, a resin, or a film layer in this application refer to the melting peak temperature of the dominant melting phase of the polymer, resin, or layer as determined by differential scanning calorimetry according to ASTM D-3418.

In embodiments where the barrier layer comprises amorphous material, then the barrier layer may not clearly display a melting point. The glass transition temperature for the barrier layer may be at least, and may range between, any of the following values: 120° C., 110° C., 100° C., 90° C., 80° C., 70° C., 60° C., 50° C., 40° C., 30° C., and 20° C.; measured where the relative humidity may be any of the following values: 100%, 75%, 50%, 25%, and 0%. All references to the glass transition temperature (T_{g}) of a polymer was determined by the Perkin Elmer “half Cp extrapolated” (the “half Cp extrapolated” reports the point on the curve where the specific heat change is half of the change in the complete transition) following the ASTM D3418 “Standard Test Method of Transition Temperatures of Polymers by Thermal Analysis,” which is hereby incorporated, in its entirety, by reference thereto.

In various embodiments, the barrier layer has a seal initiation temperature of at least any of the following values: 250° C., 240° C., 230° C., 220° C., 210° C., 200° C., 190° C., 180° C., 170° C., 160° C., 150° C., 140° C., 130° C. and 120° C.; and the seal initiation of the barrier layer may be less than any of the following values: 300° C., 290° C., 280° C., 270° C., 260° C., and 250° C.

The thickness of the barrier layer may be selected to provide sufficient material to affect a desired barrier, yet not so thick so as to negatively affect the characteristics of the film to an unacceptable level. The barrier layer may have a thickness of at least any of the following values: 0.035, 0.05 mils, 0.1 mils, 0.15 mils, 0.2 mils, 0.25 mils, 0.3 mils, 0.35 mils, 0.4 mils, 0.45 mils, 0.5 mils, and 0.6 mils. The barrier layer may have a thickness less than any of the following values: 5 mils, 4 mils, 3 mils, 2 mils, 1 mil, 0.7 mils, 0.5 mils, and 0.3 mils. The thickness of the barrier layer as a percentage of the total thickness of the film may be less that any of the following values: 80, 70, 60, 50%, 40%, 30%, 25%, 20%, 15%, 10%, and 5%; and may range between any of the forgoing values (e.g., from 10% to 30%).

The barrier layer or combination of barrier layers typically have low oxygen permeability. For example, the oxygen barrier layer(s) may result in a multi-layer film having an oxygen transmission rate of 500 cc (STP)/m2/24 hrs/1 atm or less, and in particular, less than 450, less than 400, less than 350, less than 300, less than 250, less than 200, less than 150, less than 100, less than 80, and less than 50 cc (STP)/m2/24 hrs/1 atm.

In embodiments the barrier layer and the heat seal layer have a difference in seal initiation temperature of at least 10° C., 20° C., 30° C., 40° C., 50° C., 60° C., 70° C., 80° C., 90° C. or 100° C. In embodiments the barrier layer and the heat seal layer have a difference in seal initiation temperature of between 10° C. and 100° C., 20° C. and 90° C., or 30° C. and 80° C. The barrier layer having a higher seal initiation temperature than the seal initiation temperature of the heat seal layer.

In embodiments the melting point or glass transition temperature of the barrier layer is at least 10° C., 20° C., 30° C., 40° C., 50° C., 60° C., 70° C., 80° C., 90° C. or 100° C. higher than the seal initiation temperature of the heat seal layer. In embodiments the difference between the melting point or glass transition temperature of the barrier layer and the seal initiation temperature of the heat seal layer is between 10° C. and 100° C., 20° C. and 90° C., or 30° C. and 80° C. The seal initiation temperature of the heat seal layer being the lower temperature.

The film may comprise one or more intermediate layers, such as a tie layer. In addition to a first intermediate layer, the film may comprise a second intermediate layer. “Intermediate” herein refers to a layer of a multi-layer film which is between an outer layer and an inner layer of the film. “Inner layer” herein refers to a layer which is not an outer or surface layer, and is typically a central or core layer of a film. “Outer layer” herein refers to what is typically an outermost, usually surface layer or skin layer of a multi-layer film, although additional layers, coatings, and/or films can be adhered to it.

In embodiments with multiple intermediate layers, the composition, thickness, and other characteristics of a second intermediate layer may be substantially the same as any of those of a first intermediate layer, or may differ from any of those of the first intermediate layer.

An intermediate layer may be, for example, between the heat seal layer and the barrier layer. An intermediate layer may be directly adjacent the heat seal layer, so that there is no intervening layer between the intermediate and heat seal layers. An intermediate layer may be directly adjacent the barrier layer, so that there is no intervening layer between the intermediate and barrier layers. An intermediate layer may be directly adjacent both the heat seal layer and the barrier layer.

An intermediate layer may have a thickness of at least about, and/or at most about, any of the following: 0.05, 0.1, 0.15, 0.2, 0.25, 0.5, 1, 2, 3, 4, and 5 mils. The thickness of the intermediate layer as a percentage of the total thickness of the film may be at least about, and/or at most about, any of the following: 1, 3, 5, 7, 10, 15, 20, 25, 30, 35, 40, 45, and 50 percent.

An intermediate layer may comprise one or more of any of the tie polymers described herein in at least about, and/or at most about, any of the following amounts: 10, 20, 30, 40, 50, 60, 70, 75, 80, 90, 95, and 99.5%, by weight of the layer.

A tie layer refers to an internal film layer that adheres two layers to one another. Useful tie polymers include thermoplastic polymers that may be compatible both with the polymer of one directly adjacent layer and the polymer of the other directly adjacent layer. Such dual compatibility enhances the adhesion of the tied layers to each other. Tie layers can be made from polyolefins such as modified polyolefin, ethylene/vinyl acetate copolymer, modified ethylene/vinyl acetate copolymer, and homogeneous ethylene/alpha-olefin copolymer. Typical tie layer polyolefins include anhydride modified grafted linear low density polyethylene, anhydride grafted (i.e., anhydride modified) low density polyethylene, anhydride grafted polypropylene, anhydride grafted methyl acrylate copolymer, anhydride grafted butyl acrylate copolymer, homogeneous ethylene/alpha-olefin copolymer, and anhydride grafted ethylene/vinyl acetate copolymer.

In an embodiment the tie layer includes a polyolefin. In embodiments, the tie layer includes at least 0.5, 1.0, 1.5, 2.0, 2.5 or 3.0% by weight of a polymer found in adjacent layers.

The film may comprise one or more other layers such as a bulk layer. Bulk layers are often a layer or layers of a film that can increase the abuse resistance, toughness, or modulus of a film. In some embodiments the film comprises a bulk layer that functions to increase the abuse resistance, toughness, and/or modulus of the film. Bulk layers generally comprise polymers that are inexpensive relative to other polymers in the film that provide some specific purpose unrelated to abuse-resistance, modulus, etc. In an embodiment, the bulk layer comprises at least one member selected from the group consisting of: ethylene/alpha-olefin copolymer, ethylene homopolymer, propylene/alpha-olefin copolymer, propylene homopolymer, and combinations thereof. The bulk layer may comprise all or in part recycled or reclaimed material. The bulk layer may comprise at least 50 wt % recycled or reclaimed material.

The bulk layer may have a thickness of at least about, and/or at most about, any of the following: 0.05, 0.1, 0.15, 0.2, 0.25, 0.5, 1, 2, 3, 4, and 5 mils. The thickness of the bulk layer as a percentage of the total thickness of the film may be at least about, and/or at most about, any of the following: 1, 3, 5, 7, 10, 15, 20, 25, 30, 35, 40, 45, and 50 percent.

The film may be manufactured by thermoplastic film-forming processes known in the art. The film may be prepared by extrusion or coextrusion utilizing, for example, a tubular trapped bubble film process or a flat film (i.e., cast film or slit die) process. The film may also be prepared by applying one or more layers by extrusion coating, adhesive lamination, extrusion lamination, solvent-borne coating, or by latex coating (e.g., spread out and dried on a substrate). A combination of these processes may also be employed.

The film may be oriented in either the machine (i.e., longitudinal), the transverse direction, or in both directions (i.e., biaxially oriented), for example, to enhance the strength, optics, and durability of the film. A web or tube of the film may be uniaxially or biaxially oriented by imposing a draw force at a temperature where the film is softened (e.g., above the vicat softening point; see ASTM 1525) but at a temperature below the film's melting point. The film may then be quickly cooled to retain the physical properties generated during orientation and to provide a heat-shrink characteristic to the film. The film may be oriented using, for example, a tenter-frame process or a bubble process (double bubble, triple bubble and likewise). These processes are known to those of skill in the art, and therefore are not discussed in detail here. The orientation may occur in at least one direction by at least about, and/or at most about, any of the following ratios: 1.5:1, 2:1, 2.5:1, 3:1, 3.5:1, 4:1, 5:1, 6:1, 7:1, 8:1, 9:1, 10:1, 12:1, and 15:1.

The term “bond strength” as used herein means the amount of force required to separate or delaminate the film at adjacent film layers by adhesive failure, or to cause cohesive failure within an adjacent layer, plus the force to bend the layers during the test, as measured in accordance with ASTM F904, using an Instron tensile tester crosshead speed of 10 inches per minute and five, 1-inch wide, representative samples while supporting the unseparated portion of each test specimen at 90° to the direction of draw. An “adhesive failure” is a failure in which the interfacial forces (e.g., valence forces or interlocking action or both) holding two surfaces together are overcome.

The minimum bond strength of the film is the weakest bond strength indicated from the testing of the separation at each of the layers of the film. The minimum bond strength indicates the internal strength with which a film remains intact to function as a single unit. The bond strength is provided both by inter-layer adhesion (i.e., the inter-layer adhesive bond strength) and by the intra-layer cohesion of each film layer (i.e., the intra-layer cohesive strength).

The minimum bond strength of the film may be at least about any of the following: 1, 1.5, 2, 2.5, 2.6, 2.8, 3, 3.5, 4, and 4.5 pounds/inch. The minimum bond strength between each of the adjacent layers of a plurality of layers of the film may be at least about any of the values in the preceding sentence, measured according to ASTM F904.

The minimum bond strength between the intermediate layer and each of the layers directly adjacent the intermediate layer may be at least about any of the following: 1, 1.5, 2, 2.5, 2.6, 2.8, 3, 3.5, 4, and 4.5 pounds/inch measured according to ASTM F904.

In embodiments the multi-layer film structure has an oxygen transmission rate of no more than: 5, 10, 15, 20, 25, 30, 35, 40, 45, 50, 100, 200, 300, 400, 500, 600, 700, 800, 900, 1000, 1100, 1200, 1300, 1400, 1500, 1600, 1700, 1800, 1900, 2000, 2100, 2200, 2300, 2400, 2500, 2600, 2700, 2800, 2900, 3000, 3100, 3200, 3300, 3400, 3500, 3600, 3700, 3800, 3900 or 4000 cubic centimeters (at standard temperature and pressure) per square meter per day per 1 atmosphere of oxygen pressure differential measured at 0% relative humidity and 23° C. measured according to ASTM D-3985 which is hereby incorporated by reference in its entirety. In embodiments the multi-layer film structure has an oxygen transmission rate of less than 4000, 3000, 2000 or 1000 cubic centimeters (at standard temperature and pressure) per square meter per day per 1 atmosphere of oxygen pressure differential measured at 0% relative humidity and 23° C. measured according to ASTM D-3985. Unless otherwise stated, OTR values provided herein are measured at 0% relative humidity and at a temperature of 23° C.

In an embodiment, the film has a total polyamide content of between 1 and 30 wt %. In an embodiment, the film has a total polyamide content of between 2 and 20 wt %. In an embodiment, the film has a total polyamide content of between 3 and 12 wt %. In an embodiment, the film has a total polyamide content of between 4 and 8 wt %.

In an embodiment, the film has a total polyolefin content of between 70 and 99 wt %. In an embodiment, the film has a total polyolefin content of between 80 and 95 wt %. In an embodiment, the film has a total polyolefin content of between 85 and 90 wt %.

Film transparency (also referred to herein as film clarity) was measured in accordance with ASTM D 1746-97 “Standard Test Method for Transparency of Plastic Sheeting”, published April 1998, which is hereby incorporated, in its entirety, by reference thereto. The results are reported herein as “percent transparency”. The multilayer film can exhibit a transparency of at least 15 percent, or at least 20 percent, or at least 25 percent, or at least 30 percent, measured using ASTM D 1746-97.

Film haze values were measured in accordance with ASTM D 1003-00 “Standard Test Method for Haze and Luminous Transmittance of Transparent Plastics”, published July 2000, which is hereby incorporated, in its entirety, by reference thereto. The results are reported herein as “percent haze”. The multilayer film can exhibit a haze of less than 7.5 percent, or less than 7 percent, or less than 6 percent, measured using ASTM D 1003-00.

Film gloss values were measured in accordance with ASTM D 2457-97 “Standard Test Method for Specular Gloss of Plastic Films and Solid Plastics”, published Jan. 10, 1997, which is hereby incorporated, in its entirety, by reference thereto. The results are reported herein as “percent gloss”. The film can exhibit a gloss, as measured using ASTM D 2457-97, of from 60% to 100%, or from 70% to 90%.

In an embodiment, the film has a composite melt index of at least any of the following values 0.1, 0.3, 0.5, 1.0, 1.5, 2.0, 2.5, 3.0, 4.0 or 5.0 g/10 min@190° C. and 2.16 kg measured in accordance with ASTM D1238.

As used herein, the phrase “cushioning article” includes air film containing articles that are used to cushion a product inside a package during storage and/or shipping. This phrase is inclusive of (i) cushioning articles which bear the weight of the product in the package and are capable of absorbing energy if the package impacts, or is impacted by, another object, (ii) cushioning articles which secure and stabilize against lateral and/or vertical movement of the product inside the package, and are capable of absorbing energy if the package impacts, or is impacted by, another object, i.e., dunnage; and (iii) cushioning articles which fill void in the package.

As used herein, the phrase “fluid-filled chamber” refers to a closed chamber (i.e., airtight chamber having a closure seal or seals) which is filled with fluid. The fluid can be gas or liquid or a combination of gas and liquid. The fluid-filled chamber is readily deformable when subjected to continuous or intermittent force, and thereby provides a cushioning function relative to a product in contact therewith.

As used herein, the term “matrix” is used with reference to a cushioning article strand having a plurality of discrete cells across the strand as well as a plurality of discrete cells along the length of the strand, with the cells of the strand being arranged as an array.

The phrase “air chamber article” as used herein includes cushioning material, such as BUBBLE WRAP® cellular cushioning manufactured by Sealed Air Corporation. As an example, see U.S. Pat. No. 9,017,799, which is hereby incorporated, in its entirety, by reference thereto. BUBBLE WRAP® cellular cushioning comprises one film (the “formed film”) which is bonded to another film (the “backing film”). Conventional methods of making cellular cushioning have utilized a combination of heat and vacuum to thermoform the discrete regions, as described in U.S. Pat. No. 3,294,387, to Chavannes, which is hereby incorporated, in its entirety, by reference thereto. The phrase “air chamber article” also include cushioning articles resulting from sealing two films (or the two leaves of a folded film, or a lay-flat tubing slit open along one lay-flat edge) together in a pattern of discrete sealed area(s) that leave a plurality of open inflatable chambers between the films. The inflatable article is generally shipped uninflated to the initial use destination, and stored uninflated at the initial use destination, in order to increase the efficiencies of storage and shipment. Inflatable air chamber cushioning articles are generally, but not always, designed to be inflated to superatmospheric pressure, i.e., the inflated chambers are designed to be inflated to an air pressure higher than the air pressure of the ambient environment in which the inflation and closure sealing takes place.

The formed film can be thermoformed, calendered or formed by similar methods to provide a plurality of discrete formed regions separated by a “land area.” The discrete formed regions appear as protrusions when viewed from one side of the formed film, and as cavities when viewed from the other side (i.e., the “backside”) of the formed film. In one embodiment the protrusions are regularly spaced and have a cylindrical shape, with a round base and a domed top. In one embodiment, the backing film is a flat film, i.e., is not thermoformed. In another embodiment, the backing film also has discrete formed regions separated by a land area, with the land areas of the backsides of the two formed films being laminated to one another to form a “double bubble” air cellular product. In double bubble air cellular articles, the cavities of the first formed film may be fully aligned with respective cavities of the second formed film; alternatively, the cavities may be partially aligned/partially offset from each other; alternatively, the cavities may be fully offset from each other. Air cellular cushioning articles are designed to have formed cells containing air at ambient pressure, i.e., at the air pressure of the ambient environment in which the manufacturing process takes place.

When being readied for use, the open inflatable chambers are inflated and sealed closed. The chambers may be of one or more of a variety of forms, including: (a) chambers of uniform size their length and/or width, and/or (b) chambers of non-uniform size along their length and width, particularly chambers made up of a plurality of inflated cells connected by connecting channels. Various inflatable air chamber cushioning articles for use in packaging and other end uses are disclosed in U.S. Pat. No. 3,660,189 (Troy), U.S. Pat. Nos. 4,576,669 and 4,579,516 (Caputo), U.S. Pat. No. 4,415,398 (Ottaviano), U.S. Pat. Nos. 3,142,599, 3,508,992, 3,208,898, 3,285,793, and 3,616,155 (Chavannes), U.S. Pat. No. 3,586,565 (Fielding), U.S. Pat. No. 4,181,548 (Weingarten), U.S. Pat. No. 4,184,904 (Gaffney), U.S. Pat. No. 6,800,162 (Kannankeril), U.S. Pat. No. 7,225,599 (Sperry), each of which is hereby incorporated, in its entirety, by reference thereto.

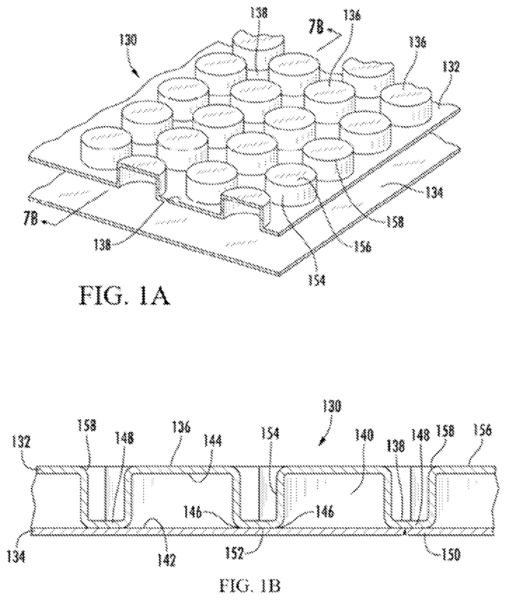

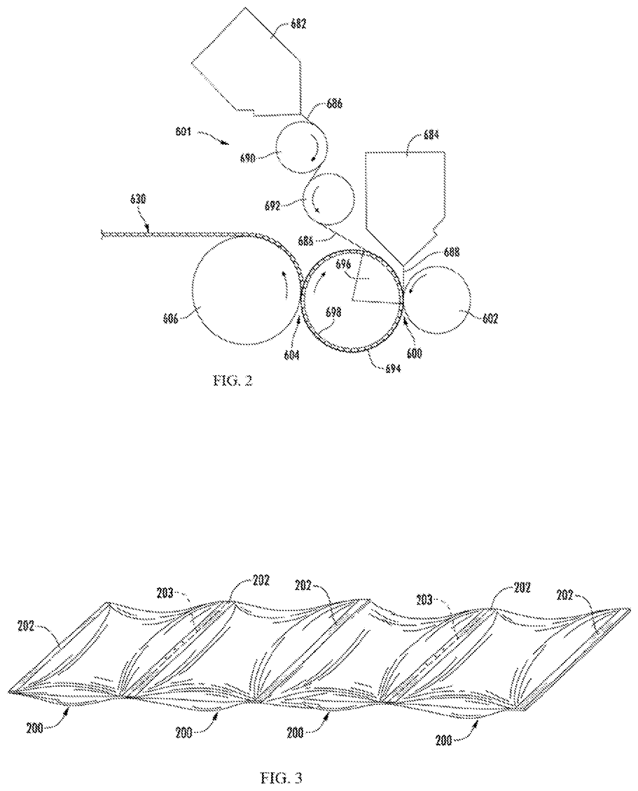

FIG. 1A is an exploded perspective view of a schematic of cellular cushioning article 130 according to an embodiment. FIG. 1B is a cross-sectional view of assembled cellular cushioning article 130, taken through section 7B-7B of FIG. 1A. Viewing FIG. 1A and FIG. 1B together, cellular cushioning article 130 includes first film 132 and second film 134. Second film 134, herein also referred to the “backing film,” is a flat film, i.e., not thermoformed. First film 132, hereinafter also referred to as the “thermoformed film,” has discrete thermoformed regions 136, each of which has a generally circular cross-section, i.e., a circular “footprint.” Moreover, the spacing of thermoformed regions 136 is such that cellular cushioning article 130 is capable of providing flexible cushioning for an object to be surrounded thereby, or otherwise in close contact therewith.

As shown, second film 134 is adhered to first film 132 at land area 138 such that first and second films 132, 134 together form a plurality of discrete cells 140 enclosed by the plurality of inside surfaces 144 of each discrete thermoformed region 136 together with the corresponding plurality of inside surfaces of discrete regions 142 of second film 134 that remain unbonded to first film 132 and are juxtaposed opposite each discrete thermoformed region 136, together with the plurality of discrete edge regions 146 of the bond between first film 132 and second film 134.

Inside surface 148 of land area 138 of thermoformed first film 132 is bonded to inside surface 150 of second film 134 at bond 152. Bond 152 is a hermetic bond that can be a heat weld, i.e., heat seal, or can be made using an adhesive applied to inside surface 148 of land area 138 and/or to the inside surface 150 of second film 134. Hermetic bond 152 provides an airtight closure to ensure that cells 140 retain the fluid entrapped therein as land area 138 of first film 132 is bonded to inside surface 150 of second film 134 to produce bond 152. The fluid entrapped in cells 140 can be gas or liquid. In each of the examples below which are or comprise such air cells, the fluid is air.

The plurality of discrete thermoformed regions 136 in first film 132 may be made of any desired shape or configuration, with uniform or tapered walls. In various embodiments made using vacuum to draw the regions into a cavity of a forming drum, the film thickness in thermoformed regions 136 tapers, with the thinnest film being in the region in which side wall 154 transitions into top surface 156, i.e., a “rim” region 158. This thinning down of the film is not illustrated. Alternatively, the thinnest portion of the film in the thermoformed region can be that portion of the thermoformed region that is farthest from the second film 134, as discussed in the above-incorporated U.S. Pat. No. 3,294,387, which is hereby incorporated, in its entirety, by reference thereto. Although thermoformed regions 136 are illustrated with a circular cross-sectional shape and a flat top, other shapes, e.g., a domed top, a half sphere, other portion of a sphere and irregular shapes are possible.

First film 132 may have a thickness (before thermoforming) of from about 0.5 to 10 mils, such as from 1 to 5 mils, 1 to 4 mils, etc. When second film 134 is not thermoformed, it may have a thickness of from about 0.05 to 3 mils, such as from 0.1-2 mils, 0.2 to 1 mil, etc. When second film 134 is thermoformed, its thickness may be the same or similar to first film 122, e.g., within the ranges as described immediately above relative to film 132.

Thermoformed regions 136 may have a height of from about 1 mm to 30 mm, or 6 to 13 mm, and a diameter (or major dimension) of from 2 mm to 80 mm, or from 4 mm to 35 mm. As the height and diameter of thermoformed regions 136 pockets is increased, the thickness of the land area of first film 132 may also be increased, and the thickness of flat second film 134 may also be increased.

First film 132 can be thicker (before thermoforming) than second film 134. First film 132 may have a fairly thin gauge, e.g., 0.1 to 0.5 mils, while the second film 114 may be relatively thicker and/or stiffer to lend support for the structure. Thus, any number of variations may be made in the thickness of the sealed films and the size and configuration of the formed portions, in order to attain any desired shock absorbing action.

The cellular cushioning article, having the formed film with a land area to which the backing film is bonded, can, without additional components, be converted to a cushioning article by being folded and sealed to itself to make a packaging article such as a pouch or mailer. In an embodiment, a strand of cellular cushioning article is folded to form a bottom edge and then sealed transversely with a single transverse seal, or with a closely-spaced pair of seals, leaving an open top along the film edges opposite the bottom edge fold, a first side seal up a first side edge, and a second side seal up a second side edge. The seals can be impulse seals, hot bar seals, hot wire seals, or seals of any other desired type. One side wall can have an extension which serves as a closure flap. Optionally, a line of weakness can be provided within some or all of the transverse seals, or between closely spaced transverse seals.

In an embodiment, transverse seals are trim seals made with a hot wire. Trim seals made with a hot wire cut a downstream portion of the strand off of the remainder of the strand, and can bond the front wall to the rear wall on the folded strand downstream of the trim seal as well as bonding the front wall to the rear wall upstream of the trim seal.

FIG. 3 illustrates inflated packaging cushions 200 made from an air impermeable thermoplastic film according to an embodiment. The cushions can be formed from two distinct films bonded together along the perimeter or from a tube of material as disclosed in U.S. Pat. No. 5,942,076, hereby incorporated, in its entirety, by reference thereto. Each cushion is formed along weld lines 202 and inflated as described in U.S. Pat. No. 5,942,076. Packaging cushions 200 are formed in a series attached to each other and may in some embodiments be separated along perforated line 203. Tubing refers to a seamless film tubing or a backseamed tubing in the form of a lap sealed tubing, a fin sealed tubing, or a butt sealed tubing having a backseaming tape. As used herein, with respect to film tubing and packaging articles made therefrom, the phrase “in lay-flat configuration” refers to a tubing or packaging article comprising a tubing that is in a flattened state with a first lay-flat side and a second lay flat side which are connected to one another along side edges which can be creased edges or sealed edges.

FIG. 4 illustrates an embodiment in which two separate films are sealed together to make a strand of packaging cushions 300, as disclosed in U.S. Pat. No. 7,225,599, hereby incorporated, in its entirety, by reference thereto. Individual cushions 302 are made by sealing together two strands of juxtaposed film plies 304 and 306, by making transverse seals 308 and longitudinal seals 314 and separation transverse seal 312. The cushions are inflated by sealing the films together with a series of spaced-apart transverse seals 308 and one longitudinal seal 314 along one longitudinal edge of juxtaposed film plies 304 and 306, and thereafter blowing air into the open ends of each open cushion followed by sealing the open ends closed with second longitudinal seal 314, as disclosed in U.S. Pat. No. 7,225,599.

Although not illustrated, a strand of inflated packaging cushions could be made by folding a strand of flat film to provide a folded strand edge with two juxtaposed film leaves extending transversely therefrom with the leaves juxtaposed against each other, making transverse seals at intervals across the juxtaposed film leaves from the fold line to provide a series of open chambers each having an open end along the remaining unsealed longitudinal edge of the folded film strand, blowing air into each of the open chambers, and thereafter sealing each chamber closed along its unsealed longitudinal edge.

In embodiments, at least one of the films used to make the packaging cushions described herein includes a gas barrier layer to enhance the gas retention of the packaging cushions while under load during use. Depending upon the cushioning protection desired, the width and length of the cushions may vary but are generally in the range of 3″ by 3″ to 12″ by 12″ or larger.

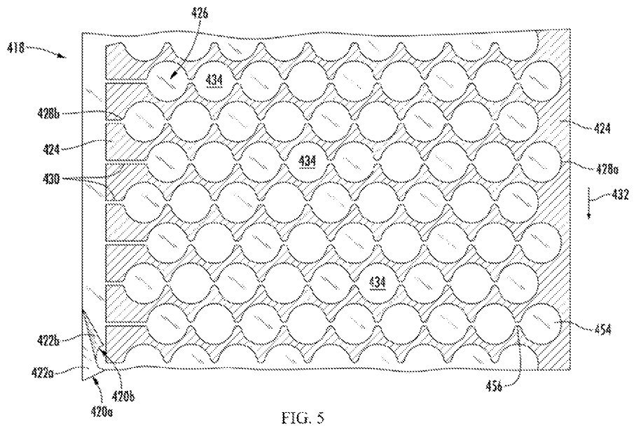

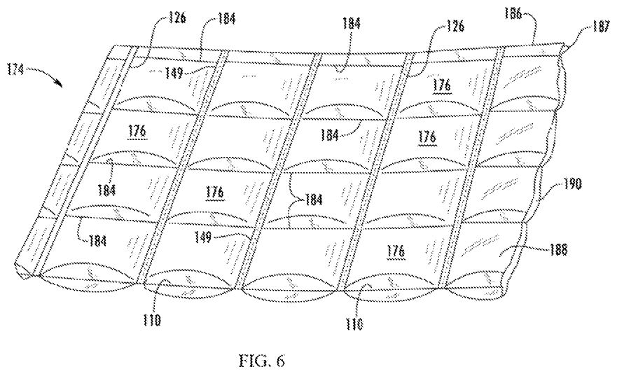

FIG. 5 illustrates a schematic of a portion of a strand of inflatable cushioning article as an inflatable web 418 in lay-flat configuration, i.e., before it has been inflated and sealed closed according to an embodiment. Two sheets 420a,b having respective inner surfaces 422a,b sealed to each other in a seal pattern 424 defining a series of inflatable chambers 426 having a closed distal end 428a and an open proximal end 428b, with the open proximal ends 428b providing an inflation port 430 for each of the inflatable chambers 426. The inflatable chambers 426 are composed of a plurality of cells 434 connected by connecting channels 456, with each inflatable chamber 426 terminating at terminal cell 454. The inflatable chambers 426 are generally arrayed in a substantially transverse orientation to a longitudinal dimension 432 of the inflatable web 418. The longitudinal dimension 432 of inflatable web 418 is the longest dimension of the web (i.e., the length-wise dimension), and is generally parallel to the direction in which the supply of inflatable pouches travels through the inflation system, as described in US Pub. No. 2014-0314798, which is hereby incorporated, in its entirety, by reference thereto.

As inflatable cushioning article 418 as illustrated is a composite article made from two discrete films bonded together, the films may be the same or different in their composition and construction. Alternatively, a similar inflatable cushioning article could be made using a folded flat film or from a film tubing that is slit, as described in U.S. Pat. No. 6,800,162, which is hereby incorporated, in its entirety, by reference thereto. In all these embodiments, the films are designed to have a barrier layer to allow the cushioning article to retain air while under load. Suitable films are described in various examples herein.

FIG. 6 illustrates a portion of a strand of cushioning article 174 comprising a grid of inflated pillows 176 separated by longitudinal seals 184 and transverse seals 126. Cushioning article 174 is made by folding a single film strand lengthwise along fold line 110 to provide two film leaves 188 and 190 extending transversely away from fold line 110. Opposite fold line 110 are first film edge 186 and second film edge 187.

As disclosed in U.S. Pat. No. 7,225,599, which is hereby incorporated, in its entirety, by reference thereto, cushioning article 174 is made by first folding the film and making a series of longitudinal seals 184, the air being blown into the channels between lengthwise seals 184. Then transverse seals 126 are made across the inflated channels to produce the grid of inflated pillows 176. The strand of cushioning article 174 may be torn transversely at a desired length using transverse lines of weakness 149. The combination of lengthwise seals 184 and transverse seals 126 allow the final “quilted” cushioning article to be thinner and more flexible for use as a cushion for packaging and other end uses, versus providing only lengthwise seals 184 or transverse seals 126.

Although inflated cushioning article 174 as illustrated and described above is made from a single folded film (the folded film could be a folded flat film, or could be derived from a film tubing slit down one edge), in another embodiment it is made from two discrete films bonded together. The two films may be the same or different in their composition and construction. In embodiments at least one of the films is provided with a barrier layer to allow the cushioning article to retain air while under load. Various films and assemblies of films are described in examples set forth herein.

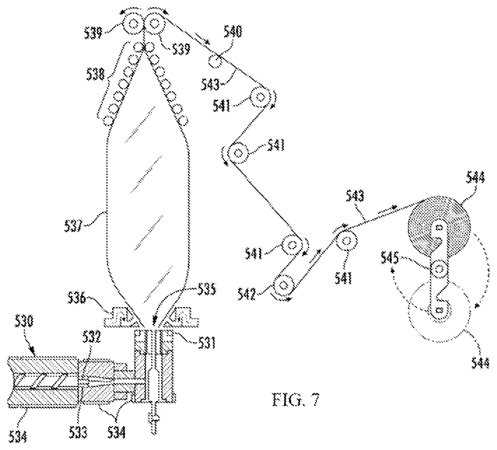

In embodiments, the film was produced by the blown film process illustrated in FIG. 7, which illustrates a schematic view of a process for making a “hot-blown” film, which is oriented in the melt state, and therefore is not heat-shrinkable. Although only one extruder 139 is illustrated in FIG. 7, it is understood that more than one extruder can be utilized to make the films.

In the process of FIG. 7, extruder 530 supplied molten polymer to annular die 531 for the formation of the film, which can be monolayer or multilayer, depending upon the design of the die and the arrangement of the extruder(s) relative to the die, as known to those of skill in the art. Extruder 530 was supplied with polymer pellets suitable for the formation of the film. Extruder 530 subjected the polymer pellets to sufficient heat and pressure to melt the polymer and forward the molten stream through annular die 531.

Extruder 530 was equipped with screen pack 532, breaker plate 533, and heaters 534. The film was extruded between mandrel 535 and die 531, with the resulting extrudate being cooled by cool air from air ring 536. The molten extrudate was immediately blown into blown bubble 537, forming a melt oriented film. The melt oriented film cooled and solidified as it was forwarded upward along the length of bubble 537. After solidification, the film tubing passed through guide rolls 538 and was collapsed into lay-flat configuration by nip rolls 539. The collapsed film tubing was optionally passed over treater bar 540, and thereafter over idler rolls 541, then around dancer roll 542 which imparted tension control to collapsed film tubing 543, after which the collapsed film tubing 543 was wound up as roll 544 via winder 545.

The cellular cushioning article was made by a process the produced the discrete formed regions having the open-bottomed, flat-topped, vertical-walled cylindrical form illustrated in FIGS. 1A and 1B, which process is described in, for example, U.S. Pat. No. 3,416,984, to Chavannes, as well as U.S. Pat. No. 9,017,799, to Chu et al, which patents are hereby incorporated, in their respective entireties, by reference thereto.

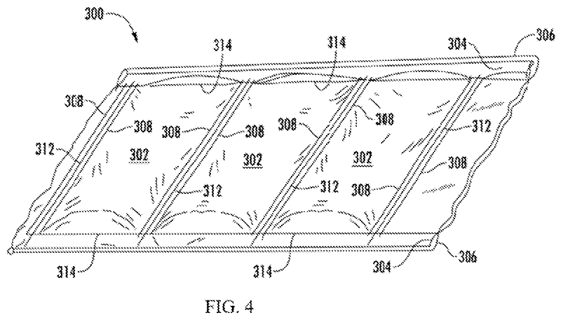

In an embodiment, the formed film and the backing film are produced in an integrated flat cast film process which is illustrated in FIG. 2, which is a schematic of an apparatus and process 601 for manufacturing the cellular cushioning article as illustrated in FIG. 1A and FIG. 1B. In FIG. 2, extrusion systems 682 and 684 extrude first film 686 and second film 688, respectively. After extrusion, first film 686 makes a partial wrap around tempering rollers 690 and 692, which may have a diameter of, e.g., 8 inches (i.e., 203 mm), and which serve to cool the first film and/or otherwise regulate the temperature of the first film so that it is at a desired temperature when it contacts thermoforming drum 694. Tempering rollers 690 and 692 are hollow. The flow of heat relative to one or both of tempering rollers 690 and 692 was controlled by controlling the temperature of liquid (e.g., water or oil) flowing through one or both of tempering rollers 690 and 692. For example, the water or oil flowing through the tempering rollers could be cooled (or heated) so as to enter tempering roller 690 and/or 692 at a temperature of from 40° F. to 350° F. during the process of manufacturing the cellular cushioning article. The heat flow is also affected by the rate of flow of liquid through tempering rollers 690 and/or 692. The tempering rollers can be used to cool the film to the solid state while also keeping the film hot enough to undergo thermoforming upon contact with vacuum forming drum 694. Tempering rollers 690 and 692 can be identical or different.

Upon exiting contact with second tempering roller 692, first film 686 is forwarded into contact with vacuum forming drum 694, which may be maintained at a temperature sufficient to permit first film 686 to (a) be thermoformed, (b) bond with second film 688, and (c) release (i.e., without sticking) from the surface of the forming drum 694. Often, a relatively moderate temperature, e.g., around 100° F. to 200° F. (higher temperature for larger cell volume and/or thicker thermoformed films), will suffice for the foregoing purposes, depending on a number of factors, including the temperature of first film 686 as it exits second tempering roller 692, the thickness and composition of the first film 686, the temperature of second film 688 when it contacts the inside surface of the land area of first film 686 after first film is thermoformed on forming drum 694, as may be readily and routinely determined by those having ordinary skill in the art of cellular cushioning manufacture. First film 686 may contact forming drum 680 over at least a portion, but generally all, of vacuum zone 696, during which time a plurality of discrete regions of first film 686 are drawn by vacuum into a plurality of discrete forming cavities in the surface of forming drum 694, thereby producing the plurality of discrete thermoformed regions 136 in first film 132, as illustrated in FIG. 1 and FIG. 2. The size and shape of cavities 698 in forming drum 694 control the size and shape of the thermoformed regions 136 on first film 132.

As illustrated in FIG. 2, vacuum zone 696 applied vacuum to the forming cavities via small channels (not illustrated) from vacuum zone 696 into the bottom of the forming cavities on the outside surface of forming drum 694, with the vacuum being constantly applied to the portion of forming drum 694 revolving through vacuum zone 696. That is, as forming drum 694 rotates, vacuum may be applied to the running portion of forming drum 694 which is over vacuum zone 696, such that vacuum zone 696 may be a fixed vacuum zone relative to the surface of forming drum 694, which continuously moves past/over fixed vacuum zone 696.

As the now-thermoformed first film 686 proceeded through nip 600 between forming drum 694 and pressure roller 602, it is merged with second film 688, which remains hot from having been extruded shortly before contacting now-thermoformed first film 686. While in nip 600, the backside of the land area of first film 686 (now formed) contacted a corresponding portion of second film 688, with the two films being pressed together while hot. The pressing together of films 686 and 688, together with continued and/or prior heating of films 686 and/or 688 as they together passed about half way around heated forming drum 694, and through second nip 604 between forming drum 694 and take-away roller 606, resulted in a heat sealed hermetic bond 152 between the land area of the now thermoformed first film 686 and a corresponding portion of unformed second film 688, resulting in cellular cushioning article 130 (see FIG. 1A and FIG. 1B). The passage of cellular cushioning article 630 over take-away roller 606 pulled the formed regions of air cellular article 330 out of and off of thermoforming drum 694.

While various embodiments of cushioning articles made from the film described herein are exhibited. It is understood that additional cushioning articles made from the film disclosed herein are contemplated.

Melt Index Testing

The tools and equipment utilized in the Melt Index Test include: (i) DYNISCO Melt Indexer Model LMI 5000 melt flow indexer, with 2.16 kg of ergonomic stackable weights (ii) die cleaning and packaging rods (iii) wire brush for cleaning polymer residue off of the piston (iv) bit or brush for cleaning the die (v) cotton patches for cleaning the chamber (vi) spatula for cutting specimens (vii) funnel for pouring resins (viii) go/no-go gauge for checking die (die was checked every 6 months) (ix) aluminum pan (x) analytical balance accurate to 0.0001 gram, checked periodically to ensure that it was level (xi) stop watch (optional as DYNISCO Melt Indexer has a built-in timer); (xii) die plug (used if extrudate is flowing too fast).

In advance of and in preparation for the running of each melt index test (whether single resin melt index test or composite article melt index test), the DYNISCO Melt Indexer was kept turned on continuously. In advance of each test, the plunger was pulled out of the barrel holding the top insulator, and the die was pushed out and checked for cleanliness. Both the die and the plunger were cleaned before each test was conducted. The die and plunger were placed back in the barrel and reheated before each test was initiated.

Melt index measurements of individual resins, as disclosed in Table 1, were carried out in accordance with ASTM D1238, the disclosure of which is hereby incorporated, in its entirety, by reference thereto. In Table 1, the melt indices of the individual resins are disclosed as g/10 min @190 C and 2.16 kg, per ASTM D1238.

Composite Melt Index

The Composite Melt Index Test is a “composite test” in that it is carried out on an entire article. The Composite Melt Index Test is not a test carried out on a single resin present in an article to be recycled, or on a single component of an article to be recycled. Rather, the Composite Melt Index Test is always carried out on an article comprising two or more different resins in combination, and in this sense is a “composite” test.

The Composite Melt Index Test can be carried out on a multilayer film that is sealed to itself to make an article which may be, for example, a packaging article. The fact that the film is a multilayer film with at least two layers which differ in polymeric composition makes this melt index test an example of the Composite Melt Index Test. An article formed by bonding a multilayer film to itself, is considered to be a “first degree composite article”

Alternatively, the Composite Melt Index Test can be carried out on an assembly comprising a multilayer film which serves as a first component of the assembly, with the first component being bonded (e.g., heat sealed) to a second component of the assembly. The second component can have a polymeric composition which is the same as or different from the first component. If the first component and the second component are both identical multilayer films (another example of a first degree composite article), with each multilayer film having at least two layers which differ in polymeric composition, carrying out the melt index test on the assembly is a Composite Melt Index Test in that at least two different polymers are present in the assembly.

On the other hand, the Composite Melt Index Test can be carried out on an assembly of a first component (a multilayer film with at least two layers which differ in chemical composition) and a second component which has a different polymeric composition from the first component. Such an assembly article is a “second degree composite” in sense that it is a composite of a first component first and second components that are compositionally different. The phrase “second degree composite” is also inclusive of composites with three or more components with at least three of the three or more components being compositionally different from each other.

Composite Melt Index Test Procedure

The Composite Melt Index Test was carried out on composite articles (including first and second degree composite articles) by first cutting the composite article into strips followed by manually stuffing the strips into the barrel of a DYNISCO Melt Indexer Model LMI 5000 melt flow indexer, which was pre-calibrated by running a DuPont Elvax 3128 resin standard to make sure that the melt index fell within the 1.90-1.98 g/10 min range. If the composite article comprises fluid-filled chambers (i.e., chambers filled with gas or liquid), all chambers were burst before or as the composite article was cut into pieces of a size suitable to be manually stuffed into the barrel of the melt flow indexer.

Once a plurality of strips of a sample were cut, at least 4 test strips were manually stuffed into the barrel (inside diameter of 50.8 mm) of the melt flow indexer. Once the strips were in the barrel of the melt flow indexer, they were heated to 190° C. with the polyolefin therein melting so that the test strips formed a molten mass that was de-gassed by having the 2.16 kg weight on top of the piston for at least 390 seconds, which ensured that all gas bubbles exited the molten mass inside the barrel of the melt flow indexer before the material was allowed to flow through the die.

After degassing, the molten mass inside the barrel was allowed to flow down to the 2 mm orifice in the die inside the melt flow tester. The die thickness was 8 mm, which corresponded with the length of the 2 mm diameter passageway through the die. The test procedure measured the rate at which plastic flowed through the 8 mm long 2 mm diameter passageway through the die, while the plastic was heated to a temperature of 190 C and while the plastic was under a load of 2.16 kg. Unless otherwise specified, the melt index test procedure was carried out in accordance with ASTM D1238.

Air chamber articles benefit from being made with films having a barrier layer which is relatively impermeable to the component(s) of the gas inside the chambers, such as air, nitrogen, carbon dioxide, etc. Air cushioning articles made from films lacking a barrier layer, and inflatable cushioning articles made from films lacking a barrier layer, exhibit relatively high air loss from sealed chambers the cells over a period of, for example, 96 hours under a load of 1 psi. Resistance to this air loss is referred to as “creep resistance” in the industry. Air loss reduces the cushioning performance and stiffness of the cushioning article. The degree of creep resistance is proportional to the rate of transmission of air through the films from which the article is made.

The creep test being conducted as described hereinbelow, with unspecified parameters being in accordance with ASTM D2221. The tools and equipment utilized in the Creep Test include: (i) Modified Korstner static-load box per ASTM D2221 consisting of (a) a Base Plate (outer box) with load surface dimensions of 8″×6.5″ and a height of 10″ and (b) Movable Guided Platen with external dimensions of 6⅜″×6⅜″; (ii) precisely 16.0 pounds total load weight including movable guided platen, top aluminum plates and additional weights; (iii) 8″×6.5″ aluminum plates, each being about 0.25 inch thick; and (iv) a dial caliper providing 0.001 inch graduations.

### Examples

The following examples are provided to illustrate various embodiments of films, and articles made therefrom. The various resins and other components used in the making of the films are provided in Table 1, below.

TABLE 1
Resins Used in Examples

| | | Resin MI | | |
|---|---|---|---|---|
| | | (g/10 min | | |
| | | @190 C./2.16 | Resin | |
| Resin | | kg) per | Density | |
| Identity | Resin | ASTMD1238 | g/cm³ | Supplier |
| LLDPE1 | SURPASS FPS117-C | 1.0 | 0.917 | Nova |
| | Ethylene/Octene linear low density | | | |
| | polyethylene | | | |
| LLDPE2 | GT4408 Modified linear low | 2.3 | 0.919 | Westlake |
| | density polyethylene | | | Chemical |
| VLDPE1 | AFFINITY PL 1850G Very Low | 3.0 | 0.902 | DOW |
| | Density Polyethylene | | | |
| MB1 | FSU 255E antiblock and slip in low | 9.0 | 1.08 | Schulman |
| | density polyethylene | | | |
| MB2 | AntiOxidant in linear low density | 2.5 | 0.932 | Ampacet |
| | polyethylene | | | |
| EAA1 | A-C 540 Ethylene/Acrylic Acid | | 0.93 | Honeywell |
| | Copolymer | | | |
| EAA2 | PRIMACOR 1410 Ethylene/Acrylic | 1.5 | 0.938 | SK |
| | Acid Copolymer | | | Chemicals |
| HDPE1 | SCLAIR 2607 ethylene butene | 4.6 | 0.947 | Nova |
| | copolymer | | | |
| TIE1 | Petrothene NA345013 Polyethylene | 1.8 | 0.921 | Lyondell |
| | Low Density Homopolymer | | | Basell |
| BLEND1 | Blend of ethylene vinyl acetate, | 0 | | |
| | polyolefins, ethylene vinyl alcohol | | | |
| | and polyamides | | | |
| BLEND2 | Blend of ethylene vinyl acetate, | 0 | | |
| | polyolefins, ethylene vinyl alcohol | | | |
| | and polyamides | | | |

BLEND1 and BLEND2 are blends of reclaim material made from scrap content. The scrap content can include, but is not limited to cut scraps; trimmed materials; transition materials; off spec material; start up, shut down or flush material. Due to the nature of obtaining scrap material, the exact composition of the blend may vary from batch to batch.

TABLE 2
film formulations

| | | | | 94% | 94% | 94% | | |
|---|---|---|---|---|---|---|---|---|
| | | 98% | | BLEND1 & | BLEND1 & | BLEND1 & | | |
| | | LLDPE1 & | | 5% EAA1 & | 5% EAA1 & | 5% EAA1 & | | |
| | | 2% MB1 | TIE1 | 1% MB2 | 1% MB2 | 1% MB2 | TIE1 | HDPE1 |
| Film 1 | Density | 0.922 | 0.921 | 0.98 | 0.98 | 0.98 | 0.921 | 0.947 |
| 53% | Layer % | 12.0% | 10.0% | 11.0% | 34.0% | 11.0% | 10.0% | 12.0% |
| scrap | Layer | 0.24 | 0.2 | 0.22 | 0.68 | 0.22 | 0.2 | 0.24 |
| | thickness | | | | | | | |
| | (mils) | | | | | | | |

| | | | | | 94% | | | |
|---|---|---|---|---|---|---|---|---|
| | | 98% | | 90% | BLEND1 & | 90% | | 98% |
| | | LLDPE1 & | | BLEND1 & | 5% EAA1 & | BLEND1 & | | LLDPE1 & |
| | | 2% MB1 | TIE1 | 10% LLDPE2 | 1% MB2 | 10% LLDPE2 | TIE1 | 2% MB1 |
| Film 2 | Density | 0.922 | 0.921 | 0.98 | 0.98 | 0.98 | 0.921 | 0.922 |
| 29% | Layer % | 15.0% | 19.0% | 8.0% | 16.0% | 8.0% | 19.0% | 15.0% |
| scrap | Layer | 0.3 | 0.38 | 0.16 | 0.32 | 0.16 | 0.38 | 0.3 |
| | thickness | | | | | | | |
| | (mils) | | | | | | | |

| | | | 94% | | 94% | | 94% | 94% |
|---|---|---|---|---|---|---|---|---|
| | | 97% | BLEND2 & | 99% | BLEND2 & | 99% | BLEND2 & | BLEND2 & |
| | | VLDPE1 & | 5% EAA1 & | BLEND2 & | 5% EAA1 & | BLEND2 & | 5% EAA1 & | 5% EAA1 & |
| | | 3% MB1 | 1% MB2 | 1% MB2 | 1% MB2 | 1% MB2 | 1% MB2 | 1% MB2 |
| Film 3 | Density | 0.903 | 0.98 | 0.98 | 0.98 | 0.98 | 0.98 | 0.98 |
| 85% | Layer % | 10.0% | 10.0% | 17.0% | 26.0% | 17.0% | 10.0% | 10.0% |
| scrap | Layer | 0.2 | 0.2 | 0.34 | 0.52 | 0.34 | 0.2 | 0.2 |
| | thickness | | | | | | | |
| | (mils) | | | | | | | |

| | | | 89% | 89% | | 89% | 89% | |
|---|---|---|---|---|---|---|---|---|
| | | | BLEND2 & | BLEND2 & | 89% | BLEND2 & | BLEND2 & | 94% |
| | | 97% | 5% EAA1 & | 5% EAA1 & | BLEND2 & | 5% EAA1 & | 5% EAA1 & | BLEND2 & |
| | | VLDPE1 & | 1% MB2 & | 1% MB2 & | 10% LLDPE2 & | 1% MB2 & | 1% MB2 & | 5% EAA1 & |
| | | 3% MB1 | 5% EAA2 | 5% EAA2 | 1% MB2 | 5% EAA2 | 5% EAA2 | 1% MB2 |
| Film 4 | Density | 0.903 | 0.978 | 0.978 | 0.973 | 0.978 | 0.978 | 0.98 |
| 82% | Layer % | 10.0% | 14.0% | 13.0% | 26.0% | 13.0% | 14.0% | 10.0% |
| scrap | Layer | 0.2 | 0.28 | 0.26 | 0.52 | 0.26 | 0.28 | 0.2 |
| | thickness | | | | | | | |
| | (mils) | | | | | | | |

| | | 97% | | | | | | 98% |
|---|---|---|---|---|---|---|---|---|
| | | VLDPE1 & | | | | | | TIE1 & |
| | | 3% MB1 | TIE1 | TIE1 | TIE1 | TIE1 | TIE1 | 2% MB1 |
| Film 5 | Density | 0.903 | 0.923 | 0.923 | 0.923 | 0.923 | 0.923 | 0.924 |
| 0% scrap- | Layer % | 10.0% | 14.0% | 13.0% | 26.0% | 13.0% | 14.0% | 10.0% |
| 100% | Layer | 0.2 | 0.28 | 0.26 | 0.52 | 0.26 | 0.28 | 0.2 |
| PE | thickness | | | | | | | |
| | (mils) | | | | | | | |

The film properties described herein are measured in accordance with ASTM D882 “Standard Test Method for Tensile Properties of Thin Plastic Sheeting,” ASTM D1938 “Standard Test Method for Tear-Propagation Resistance (Trouser Tear) of Plastic Film and Thin Sheeting by a Single-Tear Method,” ASTM D3763 “Standard Test Method for High Speed Puncture Properties of Plastics Using Load and Displacement Sensors,” each of which are hereby incorporated, in their entirety, by reference thereto.

TABLE 3

| | | | Tensile Strength | | Elongation at Break | | Young's Mod. | |
|---|---|---|---|---|---|---|---|---|
| Film | % Scrap | Thickness | (psi) ASTMD882 | | (%) ASTM D882 | | (psi) ASTMD882 | |
| Code | material | (mil) | LD | TD | LD | TD | LD | TD |
| Film 1 | 29 | 1.9 | 3530 | 2790 | 430 | 600 | 45100 | 54200 |
| Film 2 | 53 | 2.1 | 3390 | 2210 | 410 | 9.4 | 68400 | 63700 |
| Film 3 | 85 | 2.1 | 3680 | 2180 | 330 | 8.9 | 83500 | 80600 |
| Film 4 | 82 | 2.2 | 3040 | 2200 | 310 | 10 | 76800 | 77100 |
| Film 5 | control | 1.8 | 2920 | 2410 | 370 | 580 | 28700 | 35800 |

As shown in Table 3, the Films 1-4 exhibited improved tensile strength and Young's modulus as compared to the control film (Film 5).

TABLE 4

| | | Tear Propagation | | | | Tear Resistance | | Instrumented Impact | |
|---|---|---|---|---|---|---|---|---|---|
| | | Max Load (g) | | Energy to Break (g-in) | | Max Load (g) | | Max Load (N) | EtoB (J) |
| Film | % Scrap | ASTMD1938 | | ASTMD1938 | | ASTMD1938 | | ASTM | ASTM |
| Code | material | LD | TD | LD | TD | LD | TD | D3763 | D3763 |
| Film 1 | 29 | 586 | 455 | 1010 | 916 | 530 | 570 | 17.32 | 0.22 |
| Film 2 | 53 | 298 | 560 | 389 | 942 | 398 | 715 | 8.76 | 0.02 |
| Film 3 | 85 | 32.9 | 238 | 53.4 | 167 | 424 | 734 | 10.04 | 0.09 |
| Film 4 | 82 | 55.1 | 303 | 80.3 | 221 | 394 | 672 | 10.99 | 0.03 |
| Film 5 | Control | 377 | 395 | 484 | 776 | 351 | 504 | 15.24 | 0.14 |
| | (0%) | | | | | | | | |

As shown in Table 4, adjusting the amount of scrap material has an effect on the physical properties.

TABLE 5

| | | |
|---|---|---|
| OTR | Melt | Optics |

| Film Code | (cc/m2-day-atm) | Index | Clarity | Haze |
|---|---|---|---|---|
| Film 1 | 2825 | 0.77 | 1.6 | 19.7 |
| Film 2 | 1790 | 0.77 | 0.7 | 38.7 |
| Film 3 | 1570 | | 0.2 | 91.45 |
| Film 4 | 1610 | | 0.1 | 88.5 |
| Film 5 | 4675 | | 36.2 | 8.6 |

As shown in Table 5, the Films 1-4 exhibited acceptable OTR to create an effective barrier for fluid filled cushioning articles. Having an effective barrier may help limit creep loss. The scrap concentration does have an impact on the optical properties of the film.

Creep loss calculation is performed as follows:

First, 4 samples are cut from each cushioning article. Each sample being 4″+/−¼ inch, square. If the cells in successive rows are staggered, the cutting of the 4-inch on square samples cut through approximately half of the bubbles.

Second, one aluminum plate, 8″ long by 6.5″ wide by 0.25″ thick and weighing about 565 grams is placed, in a central region of a base plate. The four samples are stacked on the plate, one directly on top of another, as a single stack. Each sample is placed bubble side up (for single bubble cushioning article) into the stack. Double sided bubble and air pillow orientation is not required. The stack of the four samples is placed in a central region of the plate.

After the four samples are stacked over in a central region of the top surface of the aluminum base plate, an aluminum top plate, also 8″ long by 6.5″ wide by 0.25″ thick and also weighing about 565 grams, is placed on top of the stack of samples so that the stack of samples is directly under a central region of the top plate. Thereafter, about 14.8 pounds of added weights are placed on top of the top plate in a manner so that the top plate remains “balanced,” i.e., so that the top plate remains substantially parallel to the bottom plate. The combined weight of the upper plate (about 1.2 pounds) and the added weights (about 14.8 pounds) is approximately 16 pounds. In this manner, each of the 4 samples in the stack are placed under a static load of 1 psi.

For each stack, an initial height measurement is taken using a dial caliper. The initial height measurement is taken after the stack of four samples is under the load of the top plate and weights for a period of 60 minutes, plus or minus 5 minutes. The initial height measurement is made by measuring the distance between the bottom plate and the top plate, the measurements being made at each of the four corners of the metal plate on top of the stack. The distance measured is from the top surface of the bottom plate to the bottom surface of the top plate. The four distance values being averaged, with the resulting height determination being designated as the initial height of the samples.

After leaving the stack of samples under the load for a total of 96 hours, plus or minus 2 hours, the final height of the samples is measured. The final height measurement is conducted in the same manner the initial height measurement. That is, the distance between the top of the bottom plate and the bottom of the top plate being again measured at each of the four corners, with the values averaged to obtain a single distance representing the final height.

The creep test is carried out at ambient room temperature and 1 atm ambient pressure, and carried out in accordance with ASTM D-2221, which is hereby incorporated, in its entirely, by reference thereto.

Creep loss is calculated by subtracting the final height from the initial height, and thereafter dividing that height difference by the initial height, thereby calculating the fractional loss of the initial height. Fractional loss is multiplied by 100 to obtain the percent creep loss. In embodiments, the cushioning article loss a creep resistance of less than 50%.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

### PARTS LIST

110—fold line
114—second film
122—first film
126—transverse seals
130—cellular cushioning article
132—first film
134—second film
136—thermoformed regions
138—land area
139—extruder
140—cells
142—discrete regions
144—inside surfaces
146—edge regions
148—inside surface
149—weakness
150—inside surface
152—bond
154—side wall
156—top surface
174—cushioning article
176—inflated pillows
184—lengthwise seal
186—first film edge
187—second film edge
188—film leaves
200—packaging cushions
202—weld lines
203—perforated line
300—packaging cushions
302—individual cushions
304—juxtaposed film plies
308—transverse seals
312—separation transverse seal
314—longitudinal seal
330—air cellular article
418—inflatable web
420a,b—sheets
422a,b—inner surfaces
424—seal pattern
426—inflatable chambers
428a—distal end
428b—proximal end
430—inflation port
432—longitudinal dimension
434—cells
454—terminal cell
456—connecting channels
530—extruder
531—annular die
532—screen pack
533—breaker plate
534—heaters
535—mandrel
536—air ring
537—blown bubble
538—guide rolls
539—nip rolls
540—treater bar
541—idler rolls
542—dancer roll
543—film tubing
544—roll
545—winder
600—nip
601—process
602—pressure roller
604—second nip
606—take-away roller
630—cellular cushioning article
680—forming drum
682—extrusion systems
686—first film
688—second film
690—tempering roller
692—second tempering roller
694—forming drum
696—vacuum zone
698—cavities

1. A multi-layer film structure comprising:
a. at least one heat seal layer having a seal initiation temperature of less than any of the following temperatures: 220° C., 210° C., 200° C., 190° C., 180° C., 170° C., 160° C., 150° C., 140° C. or 130° C.;
b. at least one barrier layer comprising a blend of a polyolefin and at least one heat resistant polymer selected from the group consisting of polyamide, ethylene vinyl alcohol, polypropylene, polyester, and blends thereof;
i. the at least one barrier layer having a calculated composite melt index of less than 1.0, or 0.5 g/10 min @190° C. and 2.16 kg measured in accordance with ASTM D1238;
ii. the at least one heat resistant polymer comprising at least 7.0, 7.5, 8.0, 8.5, 9.0, 9.5 or 10 wt % the total weight of the barrier layer; and
iii. at least 0.5 wt % of a compatibilizer;
wherein the multi-layer film structure has an oxygen transmission rate of no more than: 1000, 1100, 1200, 1300, 1400, 1500, 1600, 1700, 1800, 1900, 2000, 2100, 2200, 2300, 2400, 2500, 2600, 2700, 2800, 2900 or 3000 cubic centimeters (at standard temperature and pressure) per square meter per day per 1 atmosphere of oxygen pressure differential measured at 0% relative humidity and 23° C. measured according to ASTM D-3985.

2. The multi-layer film structure of claim 1, wherein the at least one heat seal layer has a calculated composite melt index of at least 0.5 g/10 min @190° C. and 2.16 kg measured in accordance with ASTM D1238.

3. (canceled)

4. The multi-layer film structure of claim 1 wherein at least one barrier layer has a seal initiation temperature of at least any of the following temperatures: 250° C., 240° C., 230° C., 220° C., 210° C., 200° C., 190° C., 180° C., 170° C., 160° C., 150° C., 140° C., 130° C. or 120° C. and a seal initiation temperature at least 10° C., 20° C., 30° C., 40° C., 50° C., 60° C., 70° C., 80° C., 90° C., or 100° C. higher than the seal initiation temperature of the at least one heat seal layer.

5. (canceled)

6. The multi-layer film structure of claim 1 wherein the barrier layer further comprises between 0.5-20 wt % antioxidant masterbatch selected from the group consisting of: 2,6-di(t-butyl)4-methyl-phenol (BHT), 2,2″-methylene-bis(6-t-butyl-p-cresol), phosphites, such as, triphenylphosphite, tris-(nonylphenyl)phosphite, and thiols, such as, dilaurylthiodipropionate, pentaerythritol tetrakis(3-(3,5-di-tert-butyl-4-hydroxyphenyl)propionate), and octadecyl 3-(3,5-di-tert-butyl-4-hydroxyphenyl)propionate and the antioxidant is present in the barrier layer in amount of 0.05-5.0 wt %.

7. (canceled)

8. (canceled)

9. (canceled)

10. The multi-layer film structure of claim 1 wherein barrier layer comprises at least 8%, 9%, 10%, 10%, 11%, 12%, 13%, 14%, 15%, 16%, 17%, 18%, 19% or 20% polyamide selected from the group consisting of polyamide 6, polyamide 69, polyamide 610, polyamide 612, polyamide 11, polyamide 12, polyamide 6/12, polyamide 6/66, polyamide 66/610, amorphous (6I/6T) and blends thereof.

11. (canceled)

12. (canceled)

13. The multi-layer film structure of claim 1 wherein barrier layer comprises at least 4%, 5%, 6%, 7%, 8%, 9% or 10% ethylene vinyl alcohol.

14. The multi-layer film structure of claim 1 wherein the at least one barrier layer has a calculated composite melt index of 0.0 g/10 min @190° C. and 2.16 kg measured in accordance with ASTM D1238

15. The multi-layer film structure of claim 1 wherein the multi-layer film structure has a tensile strength at break of at least 1400, 1500, 1600, 1700 or 1800 in the traverse direction measured in accordance with ASTM D882 and a tensile strength at break of at least 5400, 5600, 5800, 6000 or 6200 in the machine direction measured in accordance with ASTM D882.

16. (canceled)

17. (canceled)

18. (canceled)

19. (canceled)

20. The multi-layer film structure of claim 15 wherein the heat seal layer has a total polyolefin content of from 90 to 99 wt % based on the total composition of the heat seal layer.

21. The multi-layer film structure of claim 1 wherein the at least one barrier layer comprising a blend of polyethylene and at least two distinct heat resistant polymers selected from the group consisting of polyamide, ethylene vinyl alcohol, polypropylene, polyester, and blends thereof.

22. (canceled)

23. (canceled)

24. (canceled)

25. (canceled)

26. (canceled)

27. The multi-layer film structure of claim 1 wherein the at least heat seal layer has a seal initiation temperature of at least any of the following temperatures: 50° C., 60° C., 70,° C., 80° C., 90° C., 100° C., 110° C., 120° C., 130° C., 140° C., or 150° C.

28. The multi-layer film structure of claim 1 wherein the at least one barrier layer has a seal initiation temperature less than any of the following temperatures: 300° C., 290° C., 280° C., 270° C., 260° C., or 250° C.

29. (canceled)

30. (canceled)

31. The multi-layer film structure of claim 1 wherein the multi-layer film structure an energy to break of at least 100 g—in in either direct as measured in accordance with ASTM D1938.

32. The multi-layer structure of claim 1 wherein the film has a total polyolefin content of from 70 to 99 wt % based on total film weight.

33. (canceled)

34. The multi-layer structure of claim 1 wherein the film has a total polyamide content of from 1 to 20 wt % based on total film weight.

35. The multi-layer structure of claim 1 wherein the film has a scrap content of at least 25 wt % based on total film weight.

36. A cushioning article comprising:
a first multi-layer film structure comprising:
a. at least one heat seal layer having a seal initiation temperature of less than any of the following temperatures: 220° C., 210° C., 200° C., 190° C., 180° C., 170° C., 160° C., 150° C., 140° C. or 130° C.;
b. at least one barrier layer comprising a blend of a polyolefin and at least one heat resistant polymer selected from the group consisting of polyamide, ethylene vinyl alcohol, polypropylene, polyester, and blends thereof;
i. the at least one barrier layer having a calculated composite melt index of less than 0.5 g/10 min @190° C. and 2.16 kg measured in accordance with ASTM D1238;
ii. the at least one heat resistant polymer comprising at least 7.0, 7.5, 8.0, 8.5, 9.0, 9.5 or 10 wt % the total weight of the barrier layer; and
iii. at least 0.5 wt % of a compatibilizer;
wherein the first multi-layer film structure has an oxygen transmission rate of no more than: 1000, 1100, 1200, 1300, 1400, 1500, 1600, 1700, 1800, 1900, 2000, 2100, 2200, 2300, 2400, 2500, 2600, 2700, 2800, 2900 or 3000 cubic centimeters (at standard temperature and pressure) per square meter per day per 1 atmosphere of oxygen pressure differential measured at 0% relative humidity and 23° C. measured according to ASTM D-3985;
the heat seal layer of the first multi-layer film structure being bonded to itself or a second film.

37. The cushioning article of claim 36 wherein the second film is a second multi-layer film structure comprising:
a. at least one heat seal layer having a seal initiation temperature of less than any of the following temperatures: 220° C., 210° C., 200° C., 190° C., 180° C., 170° C., 160° C., 150° C., 140° C. or 130° C.;
b. at least one barrier layer comprising a blend of a polyolefin and at least one heat resistant polymer selected from the group consisting of polyamide, ethylene vinyl alcohol, polypropylene, polyester, and blends thereof;
i. the at least one barrier layer having a calculated composite melt index of less than 0.5 g/10 min @190° C. and 2.16 kg measured in accordance with ASTM D1238;
ii. the at least one heat resistant polymer comprising at least 7.0, 7.5, 8.0, 8.5, 9.0, 9.5 or 10 wt % the total weight of the barrier layer; and
iii. at least 0.5 wt % of a compatibilizer;
wherein the second multi-layer film structure has an oxygen transmission rate of no more than: 1000, 1100, 1200, 1300, 1400, 1500, 1600, 1700, 1800, 1900, 2000, 2100, 2200, 2300, 2400, 2500, 2600, 2700, 2800, 2900 or 3000 cubic centimeters (at standard temperature and pressure) per square meter per day per 1 atmosphere of oxygen pressure differential measured at 0% relative humidity and 23° C. measured according to ASTM D-3985;
the heat seal layer of the first multi-layer film being bond to the heat seal layer of the second multi-layer film.

38. (canceled)

39. (canceled)

40. (canceled)

41. (canceled)

42. (canceled)

43. The cushioning article according to claim 36, wherein the cushioning article is a strand comprising a matrix of closed fluid-filled chambers and the closed fluid-filled chambers exhibit a creep loss of less than 50% when placed under a load of 1 psi for 96 hours, the percent creep resistance being carried out in accordance with ASTM D2221.

44. (canceled)

45. (canceled)

46. (canceled)

47. (canceled)

48. (canceled)

49. (canceled)

50. (canceled)

51. (canceled)

52. Method of making a cushioning article comprising the steps of:
a. providing a multilayer film comprising:
i. at least one heat seal layer having a seal initiation temperature of less than any of the following temperatures: 220° C., 210° C., 200° C., 190° C., 180° C., 170° C., 160° C., 150° C., 140° C. and 130° C.;
ii. at least one barrier layer comprising a blend of a polyolefin and at least one heat resistant polymer selected from the group consisting of polyamide, ethylene vinyl alcohol, polypropylene, polyester, and blends thereof
1. the at least one barrier layer having a calculated composite melt index of less than 1.0, or 0.5 g/10 min @190° C. and 2.16 kg measured in accordance with ASTM D1238;
2. the at least one heat resistant polymer comprising at least 7.0, 7.5, 8.0, 8.5, 9.0, 9.5 or 10 wt % the total weight of the barrier layer; and
3. at least 0.5 wt % of a compatibilizer;
iii. wherein the multi-layer film structure has an oxygen transmission rate of no more than: 1000, 1100, 1200, 1300, 1400, 1500, 1600, 1700, 1800, 1900, 2000, 2100, 2200, 2300, 2400, 2500, 2600, 2700, 2800, 2900 or 3000 cubic centimeters (at standard temperature and pressure) per square meter per day per 1 atmosphere of oxygen pressure differential measured at 0% relative humidity and 23° C. measured according to ASTM D-3985.
b. bonding the multilayer film to itself or a second film;
c. forming a cushioning article according;
d. filing the cushioning article with a fluid; and
e. sealing the cushioning article to seal the fluid within the bonded multilayer film(s).

53. (canceled)

54. (canceled)
